(19) United States
(12) Patent Application Publication
(10) Pub. No.: US 2011/0317118 A1
(43) Pub. Date: Dec. 29, 2011

(54) LIQUID CRYSTAL DISPLAY DEVICE

(76) Inventors: Tsuyoshi Okazaki, Osaka (JP); Katsuhiko Morishita, Osaka (JP); Toshihiro Matsumoto, Osaka (JP)

(21) Appl. No.: 13/122,796

(22) PCT Filed: Jun. 11, 2009
(86) PCT No.: PCT/JP2009/060710

§ 371 Date: May 26, 2011

(30) Foreign Application Priority Data
Oct. 6, 2008 (JP) 2008259985

(51) Int. Cl. G02F 1/1343

(52) U.S. Cl. 349/141

(57) ABSTRACT

The present invention provides a liquid crystal display device which is capable of reducing occurrence of white-floating and/or color tone change. The present invention relates to a liquid crystal display device, comprising: a first substrate and a second substrate disposed opposite to each other; and a liquid crystal layer between the first substrate and the second substrate. The first substrate has a first comb-shaped electrode and a second comb-shaped electrode. The first electrode and the second electrode are planarly disposed opposite to each other in a pixel. The second substrate has a third electrode which is partially disposed in the pixel and is configured to be supplied with a predetermined electric potential. The liquid crystal layer includes a p-nematic liquid crystal which is configured to be aligned perpendicularly to substrate surfaces of the first substrate and the second substrate when no voltage is applied. In the plan view of the first substrate and the second substrate, the liquid crystal display device has a first gap and a second gap between the first electrode and the second electrode; further, the first gap is covered with the third electrode and the second gap is not covered with the third electrode.

### TECHNICAL FIELD

The present invention relates to a liquid crystal display device. The present invention specifically relates to a display device which is suitably used for a transverse bend alignment (TBA) liquid crystal display device.

### BACKGROUND ART

Liquid crystal display devices are widely used for applications such as televisions and monitors for personal computers because they consume less power and can have a light weight and a thin profile. In a general liquid crystal display device, liquid crystal molecules are tilted depending on an applied voltage and the angle of this tilting controls light transmission; that is, the light transmittance of the liquid crystal display shows angle dependence. As a result, problems such as reduction in contrast ratio and tone inversion upon halftone display occur when the display is viewed from a certain direction. Thus, conventional liquid crystal display devices generally have insufficient viewing angle characteristics, and are desired to be improved in this respect.

In such a situation, a vertical-alignment (VA) liquid crystal display device, which has a high contrast ratio, has been developed in recent years. In the VA mode, liquid crystal molecules are aligned substantially perpendicularly to substrates when a voltage between the substrates is 0 V, while the liquid crystal molecules are aligned substantially horizontally to the substrates when a voltage between the substrates is sufficiently larger than the threshold value. Further, an alignment-dividing technique has been developed. In this technique, one pixel is divided into two or more regions and the director of the liquid crystal molecules in one region is different from that in another region. In a liquid crystal display device of this technique, the liquid crystal molecules are aligned in different directions from region to region in the pixel when a voltage is applied to the liquid crystal layer, resulting in improvement of the viewing angle characteristics of the liquid crystal display device. The regions having different directors of liquid crystal molecules are also referred to as domains and the alignment-dividing technique is also referred to as a multi-domain technique.

In the alignment-divided VA mode, the alignment may be controlled by some techniques. For example, a diagonal electric field may be used, or ribs or slits formed on a transparent electrode may be used. The transparent electrode is generally made of indium tin oxide (ITO). Such a mode of a liquid crystal display device is known as a multi-domain vertical alignment (MVA) mode, advanced super view (ASV) mode, or patterned vertical alignment (PVA) mode, and these modes are put to practical use. However, display devices with these modes require a complicated production process. In addition, they show slow response similarly to the TN mode; thus, further improvement in these respects has been demanded.

In order to avoid these problems in the process of the VA mode, one display mode is proposed in which a p-nematic liquid crystal is used as a liquid crystal material and the p-nematic liquid crystal is driven by a transverse electric field (this mode is referred to as a “transverse bend alignment (TBA) mode” herein). In this mode, a transverse electric field is generated by such an electrode as a comb-shaped electrode, and the transverse electric field controls orientation of liquid crystal molecules. Further, this mode is a vertical alignment mode, and thus a high contrast ratio can be achieved. In addition, a display device of this mode has excellent viewing angle characteristics. Furthermore, this mode does not require alignment control by protrusions. Thus, the structure of the pixel is simple and the production thereof can be simplified.

On the other hand, another liquid crystal display device is disclosed which is driven by a transverse electric field and can precisely control the behavior of a liquid crystal. This liquid crystal display device comprises first and second substrates disposed opposite to each other, a liquid crystal layer charged between the first and second substrates, a first electrode disposed on the first substrate, and a second electrode disposed on the second substrate at a position shifted with respect to the first electrode in a direction parallel to the substrate surfaces, wherein a liquid crystal of the liquid crystal layer is in a state of vertical alignment, and dielectric anisotropy of the liquid crystal is positive (for example, see Patent Document 1).
Patent Document 1: JP 2000-81641 A

### DISCLOSURE OF THE INVENTION

Display modes such as an MVA mode, PVA mode, and TBA mode are commonly in a normally black mode in which a nematic liquid crystal is perpendicularly aligned when no voltage is applied under crossed-Nicols state. In addition, for the purpose of widening a viewing angle when a voltage is applied, these modes have what is called a multi-domain (in-cell self-compensation) structure in which liquid crystal molecules are symmetrically tilted about the surface-normal direction of the substrate surface when a voltage is applied. In these modes, however, the voltage-transmittance characteristics (VT characteristics) disadvantageously show different shapes between the surface-normal direction and an oblique direction (a direction with a polar angle of greater than 0°) with respect to the substrate surface. This disadvantage is particularly strongly observed at dark-color zones close to black (dark tones), and the VT characteristics at dark tones greatly depend on the polar angle. Specifically, dark images at dark tones (black images) whitely float (are tinged with white) when the direction of observing the display is shifted from the surface-normal direction of the display surface to a direction tilted therefrom. This phenomenon is also called as white-floating. In the case of a color display, color tones may change when the direction of observing the display is shifted from the surface-normal direction of the display surface to a direction tilted therefrom. This change in color tones occurs due to the same principle as of white-floating. More specifically, this change in color tones occurs due to dependence of the VT characteristics of sub-pixels (red, green, and blue) on a polar angle of the observing direction,

Such white-floating and color-tone change may also be observed in the TBA mode. In the TBA mode, the liquid crystal molecules are aligned in various directions, from substantially parallel to vertical, with respect to the substrate surfaces when a voltage is applied. As a result, the liquid crystal molecules are not symmetrically aligned in multiple observing directions each having a different polar angle and the VT characteristics change depending on a polar angle. Thus, the above-mentioned white-floating and color-tone change occur in some cases.

Even the technique disclosed in Patent Document 1 could not solve the problems of white-floating and color-tone change.

The present invention is devised under such situation, and aims to provide a liquid crystal display device which can reduce white-floating and/or color-tone change occurring when the direction of observing the display is shifted from the surface-normal direction of the display surface to a direction tilted therefrom.

The present inventors have variously studied a liquid crystal display device which can reduce white-floating and/or color-tone change occurring when the direction of observing the display is shifted from the surface-normal direction of the display surface to a direction tilted therefrom. Then, they have focused on a technique of disposing an electrode, which is not a comb-shaped electrode, on the opposite substrate. As a result, the present inventors have found out that, in the case that a substrate opposite to another substrate having a first comb-shaped electrode and a second comb-shaped electrode has a third electrode which is partially disposed in a pixel and is configured to be supplied with a predetermined electric potential, and that the third electrode is disposed so as to form a gap between the first electrode and the second electrode on which the third electrode exists (covers) and a gap between the first electrode and the second electrode on which the third electrode does not exist (does not cover) in the plan view of the substrates, liquid crystal molecules start to tilt with a lower voltage and the inclination of the VT characteristics is made to be gentle in comparison with the case of no third electrode. Therefore, the present inventors have considered that the above problems can be excellently solved and have completed the present invention.

The present invention relates to a liquid crystal display device, comprising: a first substrate and a second substrate disposed opposite to each other; and a liquid crystal layer between the first substrate and the second substrate. The first substrate has a first comb-shaped electrode and a second comb-shaped electrode. The first electrode and the second electrode are planarly disposed opposite to each other in a pixel. The second substrate has a third electrode which is partially disposed in the pixel and is configured to be supplied with a predetermined electric potential. The liquid crystal layer includes a p-nematic liquid crystal which is configured to be aligned perpendicularly to substrate surfaces of the first substrate and the second substrate when no voltage is applied. In the plan view of the first substrate and the second substrate, the liquid crystal display device has a first gap and a second gap between the first electrode and the second electrode; further, the first gap is covered with the third electrode and the second gap is not covered with the third electrode.

This invention enables formation of a region where liquid crystal molecules (first liquid crystal molecules) are tilted in a predetermined angle when a voltage is applied on a region where no third electrode is disposed in a pixel. Simultaneously, the invention also enables formation of a region where liquid crystal molecules are more tilted than the first liquid crystal molecules on a region where the third electrode is disposed in the pixel. As a result, the liquid crystal molecules start to tilt with a lower voltage than in the case that no third electrode is disposed on the second substrate. Here, the inclination of the VT characteristics is made gentler than in the case that no third electrode is disposed on the second substrate. Therefore, the VT characteristics are less changed when the direction of observing the display is shifted from the surface-normal direction of the display surface to a direction tilted therefrom, and white-floating and/or color-tone change (preferably white-floating and color-tone change) can be reduced.

The term “perpendicularly” and the like terms derived therefrom herein are not required to mean precise perpendicularity as long as a liquid crystal display device can serve as a TBA liquid crystal display device. In other words, the term “perpendicularly” and the like terms derived therefrom include “substantially perpendicularly” and the like derived therefrom.

The configuration of the liquid crystal display device of the present invention is not especially limited as long as it essentially includes such components, and the liquid crystal display device of the present invention may or may not include other components.

Preferable embodiments of the liquid crystal display device of the present invention are mentioned in more detail below. The following embodiments may be employed in combination.

The third electrode may partially cover the gap between the first electrode and the second electrode in the plan view of the first substrate and the second substrate.

The third electrode may be a band-shaped electrode which covers the first electrode, the second electrode, and the first gap together in the pixel (hereinafter, this structure is also referred to as the “first mode”). In this case, even if multiple panels according to the liquid crystal display device of the present invention are produced and a degree of displacement in attaching the first substrate and the second substrate is different among the respective panels, the VT characteristics can be less different among the panels.

In the first mode, the ratio of the area of the third electrode in the pixel is preferably not smaller than 30% and not larger than 70%, more preferably not smaller than 40% and not larger than 60%, and further preferably not smaller than 45% and not larger than 55%, to the area of the pixel. In this case, occurrence of white-floating and/or color-tone change (preferably white-floating and color-tone change) can be effectively reduced regardless of the width of each electrode and the spacing between the electrodes.

One of the first electrode and the second electrode may be a pixel electrode and the other of the first electrode and the second electrode may be a common electrode. The third electrode may be disposed apart from the pixel electrode in the plan view of the first substrate and the second substrate. In this case, occurrence of white-floating and/or color-tone change (preferably white-floating and color-tone change) can be more effectively reduced.

One of the first electrode and the second electrode may be a pixel electrode which is configured to be supplied with an alternating current. The other of the first electrode and the second electrode may be a common electrode which is set to the electric potential at the amplitude center of the pixel electrode. The third electrode may be set to the electric potential at the amplitude center of the pixel electrode.

As mentioned above, one of the first electrode and the second electrode may be a pixel electrode which is configured to be supplied with an alternating current (AC voltage); the other of the first electrode and the second electrode may be a common electrode; the electric potential of the common electrode may be set to the electric potential at the amplitude center of the alternating current which is to be applied to the pixel electrode; and the electric potential of the third electrode may be set to the electric potential at the amplitude center of the alternating current which is to be applied to the pixel electrode. In this case, white-floating and/or color-tone change (preferably white-floating and color-tone change) can be reduced while problems such as liquid crystal degradation, burn-in, and high driving voltage are also reduced.

Preferably, the electric potential of the common electrode is strictly set to the electric potential at the amplitude center of the alternating current which is to be applied to the pixel electrode; however, it is not necessarily strictly set to the electric potential at the amplitude center of the alternating current which is to be applied to the pixel electrode as long as the aforementioned effects are achieved and the set electric potential has no influence on display performance. In other words, the electric potential of the common electrode may be substantially the same as the electric potential at the amplitude center of the alternating current which is to be applied to the pixel electrode. Specifically, the electric potential of the common electrode may be up to about 10 to 20 mV higher or lower than the electric potential at the amplitude center of the alternating current which is to be applied to the pixel electrode. In this case, however, poor display performance due to flicker is feared as a short-term problem, and problems such as liquid crystal degradation and burn-in are feared as long-term problems. Thus, the electric potential of the common electrode is preferably set to the same electric potential as the electric potential at the amplitude center of the alternating current which is to be applied to the pixel electrode as much as possible.

Further, the electric potential of the third electrode is preferably set to the electric potential at the amplitude center of the alternating current which is to be applied to the pixel electrode strictly; however, it is not necessarily strictly set to the electric potential at the amplitude center of the alternating current which is to be applied to the pixel electrode as long as the aforementioned effects are achieved and the set electric potential has no influence on display performance. In other words, the electric potential of the third electrode may be substantially the same as the electric potential at the amplitude center of the alternating current which is to be applied to the pixel electrode. Specifically, the electric potential of the third electrode may be up to about 10 to 20 mV higher or lower than the electric potential at the amplitude center of the alternating current which is to be applied to the pixel electrode. In this case, however, the liquid crystal may start to slightly tilt even if the voltage of the pixel electrode is not higher than the threshold voltage of the liquid crystal layer. As a result, even when a voltage is not applied to the pixel electrode, poor display performance of excessively bright black color (black tinged with white) may occur when the display surface is observed diagonally. Further, poor display performance due to flicker is feared as a short-term problem, and problems such as liquid crystal degradation and burn-in are feared as long-term problems. Thus, the electric potential of the third. electrode is preferably set to the same electric potential as the electric potential at the amplitude center of the alternating current which is to be applied to the pixel electrode as much as possible.

One of the first electrode and the second electrode may be a pixel electrode which is configured to be supplied with an alternating current. The other of the first electrode and the second electrode may be a common electrode which is set to the electric potential at the amplitude center of the pixel electrode. The third electrode may be configured to be supplied with an alternating current having the same phase as the pixel electrode.

As mentioned above, one of the first electrode and the second electrode may be a pixel electrode which is configured to be supplied with a first alternating current (AC voltage); the other of the first electrode and the second electrode may be a common electrode; an electric potential of the common electrode may be set to an electric potential at an amplitude center of the first alternating current; and the third electrode may be configured to be supplied with a second alternating current (AC voltage) which has the same phase as the first alternating current. In this case, white-floating and/or color-tone change (preferably white-floating and color-tone change) can be reduced while problems such as liquid crystal degradation, burn-in, and high driving voltage are reduced.

Preferably, the electric potential of the common electrode is strictly set to the electric potential at the amplitude center of the first alternating current; however, it is not necessarily strictly set to the electric potential at the amplitude center of the first alternating current as long as the aforementioned effects are achieved and the set electric potential has no influence on display performance. In other words, the electric potential of the common electrode may be substantially the same as the electric potential at the amplitude center of the first alternating current. Specifically, the electric potential of the common electrode may be up to about 10 to 20 mV higher or lower than the electric potential at the amplitude center of the first alternating current. In this case, however, poor display performance due to flicker is feared as a short-term problem, and problems such as liquid crystal degradation and burn-in are feared as long-term problems. Thus, the electric potential of the common electrode is preferably set to the same electric potential as the electric potential at the amplitude center of the first alternating current as much as possible.

Preferably, in this case, the phase of the second alternating current is strictly the same as that of the first alternating current; however, it is not necessarily strictly the same as the phase of the first alternating current as long as the aforementioned effects are achieved and it has no influence on display performance. In other words, the third electrode may be supplied with a second alternating current which has substantially the same phase as the first alternating current.

The pixel preferably has multiple domains, and the third electrode is preferably disposed equally toward the multiple domains. In this case, occurrence of white-floating and/or color-tone change (preferably white-floating and color-tone change) can be reduced in any observing directions.

Preferably, the third electrode is strictly disposed equally toward the multiple domains; however, it is not required to be strictly equally disposed as long as the aforementioned effects are achieved. In other words, the third electrode may be disposed substantially equally toward the multiple domains. In practical panel production, generally, an opposite substrate (CF substrate) and an array substrate (TIT-array substrate) are attached to each other with a displacement by within ±2 μm, as well as electrode patterns are formed with a width difference by less than 1 μm upon electrode patterning (photolithography). Thus, further in consideration of the range of the variations in L/S, the third electrode may be displaced by within 1 μm from the position where it is strictly equally disposed toward the multiple domains.

The liquid crystal display device of the present invention may be a color liquid crystal display device, and the pixel may be a sub-pixel.

### EFFECT OF THE INVENTION

The liquid crystal display device of the present invention can reduce occurrence of white-floating and/or color-tone change.

### BRIEF DESCRIPTION OF THE DRAWINGS

FIG. 1 schematically show the liquid crystal display device of Embodiment 1; FIG. 1(a) is a plan view; FIG. 1(b) is a cross-sectional view at the A1-A2 line in FIG. 1(a); and FIG. 1(c) is an image showing the arrangement of the absorption axes of a pair of polarizers in the plan view of the display surface.

FIG. 2 show the simulation results of the liquid crystal display device of Embodiment 1; FIG. 2(a) shows lines of electric force in the cross-sectional view; and FIG. 2(b) shows the lines of electric force and liquid crystal directors in the cross-sectional view.

FIG. 3 shows the VT characteristics of the liquid crystal display device of Embodiment 1 obtained in the simulation.

FIG. 4 is a schematic cross-sectional view showing the liquid crystal display device of Comparative Embodiment 1.

FIG. 5 show the simulation results of the liquid crystal display device of Comparative Embodiment 1; FIG. 5(a) shows lines of electric force in the cross-sectional view; and FIG. 5(b) shows the lines of electric force and liquid crystal directors in the cross-sectional view.

FIG. 6 shows the VT characteristics of the liquid crystal display device of Comparative Embodiment 1 obtained in the simulation.

FIG. 7 shows the comparison result about white-floating between the liquid crystal display devices of Embodiment 1 and Comparative Embodiment 1.

FIG. 8 shows the comparison result about white-floating between the liquid crystal display device of Embodiment 1 with variations in the area ratio of the opposite electrode and the liquid crystal display device of Comparative Embodiment 1.

FIG. 9 is a graph showing the dependence between the effect of reducing white-floating and the area ratio of the opposite electrode, wherein the luminance ratio in the front direction is 0.2, 0.5, or 0.8.

FIG. 10 shows another comparison result about white-floating between the liquid crystal display device of Embodiment 1 with variations in the area ratio of the opposite electrode and the liquid crystal display device of Comparative Embodiment 1.

FIG. 11 is a graph showing the dependence between the effect of reducing white-floating and the area ratio of the opposite electrode, wherein the luminance ratio in the front direction is 0.2, 0.5, or 0.8.

FIG. 12 shows the VT characteristics of the liquid crystal display device (the area ratio of the opposite electrode=50%, L/S=4 μm/10 μm) of Embodiment 1 obtained in the simulation.

FIG. 13 shows the VT characteristics of the liquid crystal display device (the area ratio of the opposite electrode=0%, L/S=4 μm/10 μm) of Comparative Embodiment 1 obtained in the simulation.

FIG. 14 shows the comparison result about white-floating between the liquid crystal display device of Embodiment 1 with variations in the applied voltage and the liquid crystal display device of Comparative Embodiment 1.

FIG. 15 shows the VT characteristics of the liquid crystal display device (Applied Voltage Variation 3) of Embodiment 1 obtained in the simulation.

FIG. 16 shows the VT characteristics of the liquid crystal display device (Applied Voltage Variation 4) of Embodiment 1 obtained in the simulation.

FIG. 17 shows the VT characteristics of the liquid crystal display device (Applied Voltage Variation 5) of Embodiment 1 obtained in the simulation.

FIG. 18 shows the VT characteristics of the liquid crystal display device (Applied Voltage Variation 7) of Embodiment 1 obtained in the simulation.

FIG. 19 is a schematic cross-sectional view showing the liquid crystal display device of Embodiment 2.

FIG. 20 show the simulation results of the liquid crystal display device of Embodiment 2; FIG. 20(a) shows lines of electric force in the cross-sectional view; and FIG. 20(b) shows the lines of electric force and liquid crystal directors in the cross-sectional view.

FIG. 21 shows the VT characteristics of the liquid crystal display device of Embodiment 2 obtained in the simulation.

FIG. 22 is a schematic cross-sectional view showing the liquid crystal display device of Embodiment 3.

FIG. 23 show the simulation results of the liquid crystal display device of Embodiment 3; FIG. 23(a) shows lines of electric force in the cross-sectional view; and FIG. 23(b) shows the lines of electric force and liquid crystal directors in the cross-sectional view.

FIG. 24 shows the VT characteristics of the liquid crystal display device of Embodiment 3 obtained in the simulation.

FIG. 25 is a schematic cross-sectional view showing the liquid crystal display device of Embodiment 4.

FIG. 26 show the simulation results of the liquid crystal display device of Embodiment 4; FIG. 26(a) shows lines of electric force in the cross-sectional view; and FIG. 26(b) shows the lines of electric force and liquid crystal directors in the cross-sectional view.

FIG. 27 shows the VT characteristics of the liquid crystal display device of Embodiment 4 obtained in the simulation.

FIG. 28 is a schematic cross-sectional view showing the liquid crystal display device of Embodiment 5.

FIG. 29 show the simulation results of the liquid crystal display device of Embodiment 5; FIG. 29(a) shows lines of electric force in the cross-sectional view; and FIG. 29(b) shows the lines of electric force and liquid crystal directors in the cross-sectional view.

FIG. 30 shows the VT characteristics of the liquid crystal display device of Embodiment 5 obtained in the simulation.

FIG. 31 shows the comparison result about white-floating among the liquid crystal display devices of Embodiments 1 to 5 and Comparative Embodiment 1.

FIG. 32 is a schematic cross-sectional view showing the liquid crystal display device of Comparative Embodiment 2.

FIG. 33 show the simulation results of the liquid crystal display device of Comparative Embodiment 2; FIG. 33(a) shows lines of electric force in the cross-sectional view; and FIG. 33(b) shows the lines of electric force and liquid crystal directors in the cross-sectional view.

FIG. 34 shows the VT characteristics of the liquid crystal display device of Comparative Embodiment 2 obtained in the simulation.

FIG. 35 shows another comparison result about white-floating between the liquid crystal display device of Embodiment 1 with variations in the area ratio of the opposite electrode and the liquid crystal display device of Comparative Embodiment 1.

FIG. 36 shows the VT characteristics of the liquid crystal display device (area ratio of opposite electrode=0%, L/S=2 μm/7 μm) of Comparative Embodiment 1 obtained in the simulation.

FIG. 37 shows the VT characteristics of the liquid crystal display device (area ratio of opposite electrode=30%, L/S=2 μm/7 μm) of Embodiment 1 obtained in the simulation.

FIG. 38 shows the VT characteristics of the liquid crystal display device (area ratio of opposite electrode=50%, L/S=2 μm/7 μm) of Embodiment 1 obtained in the simulation.

FIG. 39 shows the VT characteristics of the liquid crystal display device (area ratio of opposite electrode=70%, L/S=2 μm/7 μm) of Embodiment 1 obtained in the simulation.

FIG. 40 shows the VT characteristics of the liquid crystal display device (area ratio of opposite electrode=100%, L/S=2 μm/7 μm) of Comparative Embodiment obtained in the simulation.

FIG. 41 shows the VT characteristics of the liquid crystal display device (Applied Voltage Variation 6) of Embodiment 1 obtained in the simulation.

### MODES FOR CARRYING OUT THE INVENTION

The present invention will be mentioned in more detail referring to the drawings in the following embodiment, but is not limited to this embodiment.

In the following embodiments, the 3 o'clock direction, 12 o'clock direction, 9 o'clock direction, and 6 o'clock direction in the plan view of the liquid crystal display device (on the display surface) are regarded as the 0° direction (azimuth), 90° direction (azimuth), 180° direction (azimuth), and 270° direction (azimuth), respectively; the direction passing the 3 and 9 o'clock positions is regarded as the horizontal direction, and the direction passing the 12 and 6 o'clock positions is regarded as the vertical direction.

### Embodiment 1

The liquid crystal display device of the present embodiment is a TBA mode liquid crystal display device among those with an in-plane switching mode in which an electric field in the substrate surface direction (transverse electric field) is applied to a liquid crystal layer, and thereby the orientation of the liquid crystal molecules is controlled so that an image is displayed.

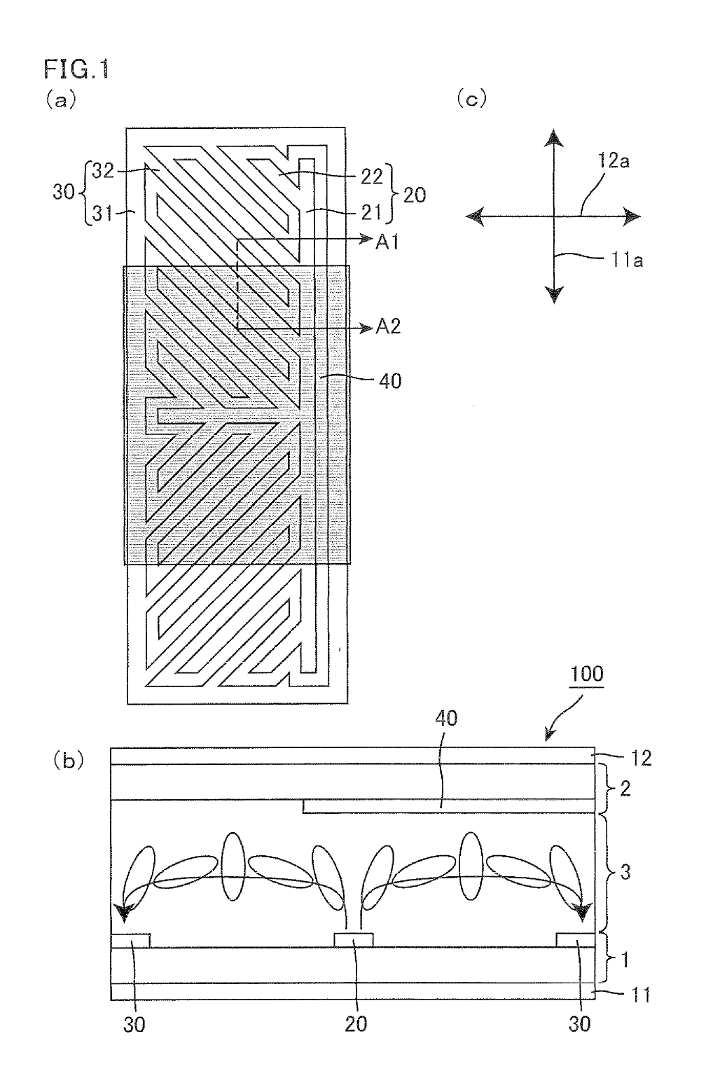

FIG. 1 schematically show the liquid crystal display device of Embodiment 1; FIG. 1(a) is a plan view; FIG. 1(b) is a cross-sectional view at the A1-A2 line in FIG. 1(a); and FIG. 1(c) is an image showing the arrangement of the absorption axes of a pair of polarizers in the plan view of the display surface. The following views illustrate only one sub-pixel; the display area (image-displaying region) of the liquid crystal display device of the present embodiment includes multiple sub-pixels arranged in a matrix manner.

The liquid crystal display device of the present embodiment comprises a liquid crystal display panel 100. The liquid crystal display panel 100 is provided with a pair of substrates disposed opposite to each other, namely, an active-matrix substrate (TFT-array substrate) 1 and an opposite substrate 2, and a liquid crystal layer 3 disposed therebetween.

Polarizers (linear polarizers) 11 and 12 are disposed on the outer main surfaces (surfaces separated from the liquid crystal layer 3) of the active-matrix substrate 1 and the opposite substrate 2, respectively. As shown in FIG. 1(c), the polarizer 11 on the active-matrix substrate is disposed such that the absorption axis 11a is along the vertical direction, while the polarizer 12 on the opposite substrate 2 is disposed such that the absorption axis 12a is along the horizontal direction. In other words, the polarizers 11 and 12 are arranged in a crossed-Nicols state. Further, the liquid crystal display panel 100 is a liquid crystal display panel of normally black mode.

The active-matrix substrate 1 and the opposite substrate 2 are attached to each other by a sealant which is applied so as to surround the display area. Further, the active-matrix substrate 1 and the opposite substrate 2 are disposed opposite to each other via spacers such as plastic beads. A liquid crystal material as a display medium constituting an optically modulating layer is charged into a gap between the active-matrix substrate 1 and the opposite substrate 2, and thereby the liquid crystal layer 3 is formed in the gap.

The liquid crystal layer 3 contains a nematic liquid crystal material (p-nematic liquid crystal material) having positive dielectric anisotropy. The liquid crystal molecules of the p-nematic liquid crystal material show homeotropic alignment when no voltage is applied (no electric field is generated among the below-mentioned pixel electrode 20, common electrode 30, and opposite electrode 40) due to alignment-control force of a vertical-alignment film disposed on the surfaces of the active-matrix substrate 1 and the opposite substrate 2 on the sides adjacent to the liquid crystal layer 3. Specifically, the long axes of the liquid crystal molecules in the p-nematic liquid crystal material form an angle of 88° or greater (preferably 89° or greater) with the active-matrix substrate 1 and the opposite substrate 2 when no voltage is applied.

The panel retardation dΔn (the product of the cell gap d and the birefringence Δn of the liquid crystal material) is preferably 275 to 460 nm, and more preferably 280 to 400 nm. In other words, the lower limit of dΔn is preferably not smaller than a half of the wavelength 550 nm (green) in consideration of the mode, while the upper limit of dΔn is preferably within the range where dΔn is compensated by the retardation Rth in the surface-normal direction of a negative C plate monolayer. The negative C plate is disposed so as to compensate white-floating and/or color-tone change occurring when the direction of observing a black image is shifted from the surface-normal direction of the display surface to a direction tilted therefrom. The compensation can be achieved by stacking multiple negative C plates to increase Rth, but this method is not preferable because it costs high. The liquid crystal material has a dielectric constant Δ∈ of preferably 10 to 25, and more preferably 15 to 25. The lower limit of Δ∈ is preferably not lower than about 10 (more preferably 15) for a low white voltage (voltage upon displaying a white image). Further, Δ∈ is preferably as large as possible for a lower driving voltage. On condition that an easily available material at present is used, however, the upper limit of Δ∈ is preferably not higher than 25 as mentioned above.

The opposite substrate 2 is provided with a black matrix (BM) layer which blocks light between the sub-pixels, color layers (color filters) which are disposed corresponding to the respective sub-pixels, opposite electrodes 40 which are disposed on the BM layer and the color layers at the side adjacent to the liquid crystal layer 3, and a vertical-alignment film which is disposed on the surface adjacent to the liquid crystal layer 3 so as to cover these components, on one main surface (adjacent to the liquid crystal layer 3) of a colorless transparent insulating substrate. The BM layer is made of a material such as an opaque metal (e.g. Cr) or an opaque organic film such as a carbon-containing acrylic resin, and is disposed on a boundary region between adjacent sub-pixels. On the other hand, the color layers are prepared for the purpose of color display and are made of a material such as a transparent organic film (e.g. acrylic resin containing a pigment); they are mainly formed on sub-pixel regions.

As mentioned here, the liquid crystal display device of the present embodiment is a color liquid crystal display device (active matrix-type liquid crystal display device for color display) provided with the color layers on the opposite substrate 2; each pixel consists of three sub-pixels, that is, red (R), green (G), and blue (B) light-outputting sub-pixels. The color and the number of the sub-pixels constituting the pixels are not particularly limited, and may be designed as appropriate. In other words, each pixel may consist of three sub-pixels of cyan, magenta, and yellow, or may consist of four or more color sub-pixels in the liquid crystal display device of the present embodiment.

On the other hand, the active-matrix substrate 1 is provided with gate bus lines, Cs bus lines, source bus lines, TFTs which serve as switching elements and which are disposed to the respective sub-pixels in one-to-one correspondence, drain lines (drains) connected to the respective TFTs, pixel electrodes 20 disposed on the respective sub-pixels, a common electrode 30 shared by all of the sub-pixels, and a vertical-alignment film which covers these components and is disposed on the surface adjacent to the liquid crystal layer 3, on one main surface (adjacent to the liquid crystal layer 3) of a colorless transparent insulating substrate.

The vertical-alignment films disposed on the active-matrix substrate 1 and the opposite substrate 2 are formed by applying a known alignment film material such as polyimide to the substrates. Vertical-alignment films are not rubbed in general, but make the liquid crystal molecules be aligned substantially perpendicularly to the film surface when no voltage is applied.

As shown in FIG. 1, the pixel electrodes 20 are formed corresponding to the respective sub-pixels and the common electrode 30 is continuously (integrally) formed corresponding to all of the adjacent sub-pixels on the active-matrix substrate 1 at the side adjacent to the liquid crystal layer 3. On the other hand, the opposite electrodes 40 each are continuously (integrally) formed corresponding to the line (sub-pixel line) consisting of multiple sub-pixels adjacent to each other in the horizontal direction on the opposite substrate 2 at the side adjacent to the liquid crystal layer 3. The display region includes multiple sub-pixel lines, and the opposite electrodes 40 are disposed corresponding to the respective sub-pixel lines.

Each of the pixel electrode 20 is configured to receive a predetermined level of an image signal from the corresponding source bus line (width is 5 μm, for example) via the thin film transistor (TFT) which is a switching element. Here, the source bus line extends through a gap between adjacent sub-pixels in the vertical direction. The pixel electrode 20 is electrically coupled with the drain line of the TFT via a contact hole formed on the interlayer insulating film. Further, the common electrode 30 is configured to receive a common signal which is common the respective sub-pixels. In addition, the common electrode 30 is coupled with a circuit which generates the common signal (common-voltage-generating circuit) and is set to a predetermined electric potential. On the other hand, the common signal which is common to the respective sub-pixels is also applied to the opposite electrodes 40. Each of the opposite electrode 40 is coupled with the common-voltage-generating circuit and is set to a predetermined electric potential.

The source bus lines are coupled with a source driver (data-line-driving circuit) outside the display region. The gate bus lines (width is 5 μm, for example) each extend through a gap between adjacent sub-pixels in the horizontal direction. The gate bus lines are coupled with a gate driver (scanning-line-driving circuit) outside the display region, and are coupled with the gates of the TFTs inside the display region. Further, each of the gate bus line is supplied with a scanning signal in a pulsed manner from the gate driver at predetermined intervals. The scanning signal is applied to the TFTs by a line sequential method. Then, the TFTs are switched on for a predetermined period by the input of the scanning signal, and an image signal is applied to the pixel electrodes 20 coupled with the TFTs at a predetermined timing while the TFTs are switched on. As a result, the image signal is written on the liquid crystal layer 3.

As the image signal is written on the liquid crystal layer 3, it is maintained for a predetermined period by the pixel electrode 20 supplied with the image signal, the common electrode 30, and the opposite electrode 40 opposite to the pixel electrode 20. In other words, a capacity (liquid crystal capacity) is formed for a predetermined period by the pixel electrode 20, the common electrode 30, and the opposite electrode 40. Further, a retention capacity is formed parallel to the liquid crystal capacity in order to prevent leakage of the maintained image signal. The retention capacity is formed between the drain line of the TFT and the Cs bus line (capacity-retention wiring, width thereof is 5 μm, for example) in each of the sub-pixels. The Cs bus lines are disposed in parallel with the gate bus lines.

The pixel electrode 20 is made of a transparent conductive film such as ITO, a metal film such as aluminum or chromium, or the like. The pixel electrode 20 has a comb-like shape in the plan view of the liquid crystal display panel 100. Specifically, the pixel electrode 20 has a trunk portion (connecting portion) 21 having a T shape in the plan view and linear branch portions (comb teeth) 22 in the plan view. The trunk portion 21 extends in the vertical and 180° directions such that it vertically bisects the sub-pixel region. The branch portions 22 are connected to the trunk portion 21 and each extend in the 135° direction or the 225° direction.

The common electrode 30 is also made of a transparent conductive film such as ITO, a metal film such as aluminum, or the like, and it has a comb-like shape in the plan view in each sub-pixel. Specifically, the common electrode 30 has a trunk portion (connecting portion) 31 in a grid pattern in the plan view and linear branch portions (comb teeth) 32 in the plan view. The truck portion 31 extends in the vertical and horizontal directions such that it covers the gate bus lines and the source bus lines in the plan view. The branch portions 32 are connected to the trunk portion 31 and each extend in the 45° direction or the 315° direction.

As mentioned here, the branch portions 22 of the pixel electrode 20 and the branch portions 32 of the common electrode 30 each have a shape planarly complementary to each other, and are alternately arranged at predetermined intervals. In other words, the branch portions 22 of the pixel electrode 20 and the branch portions 32 of the common electrode 30 are arranged in parallel opposite to each other in the same plane. That is, the comb-shaped pixel electrode 20 and the comb-shaped common electrode 30 are disposed opposite to each other such that the comb teeth (branch portions 22 and branch portions 32) are engaged with each other. Thus, a high-density transverse electric field can be formed between the pixel electrode 20 and the common electrode 30, and the liquid crystal layer 3 can be more precisely controlled. Further, the pixel electrode 20 and the common electrode 30 each have a shape symmetrical about the center line which extends in the horizontal direction passing through the center of the sub-pixel.

As is mentioned later, two domains whose director directions are different from each other by 180° are formed in the gaps between the pixel electrode 20 and the common electrode 30. Further, the direction of the electric field applied between the pixel electrode 20 and the common electrode 30 in the upper region of the sub-pixel is orthogonal to that in the lower region of the sub-pixel. Thus, a single sub-pixel includes four domains (first to fourth domains) in total.

The width (length in the lateral direction) of the respective branch portions 22 of the pixel electrode 20 is substantially the same as the width (length in the lateral direction) of the respective branch portions 32 of the common electrode 30. For the purpose of increasing transmittance, the widths of the pixel electrode 20 and the common electrode 30 (the widths of the branch portions 22 of the pixel electrode 20 and the branch portions 32 of the common electrode 30) are preferably as narrow as possible; with a process rule at present, the widths are preferably set to about 1 to 5 μm (more preferably 1.5 to 4 μm). Hereinafter, the widths of the branch portions 22 and 32 are also referred to simply as the line widths L.

The spacing S between the pixel electrode 20 and the common electrode 30 is not particularly limited; it is preferably 1.0 to 20 μm (more preferably 1.5 to 13 μm). If the spacing is greater than 20 μm, the response may be extremely slow in some cases. In addition, the VT characteristics may greatly shift to the high-voltage side, so that an applied voltage may be beyond the voltage tolerance of the source driver. If the spacing is less than 1.0 μm, in contrast, the pixel electrode 20 and the common electrode 30 may not be formed by photolithography.

The opposite electrode 40 is made of a transparent conductive film such as ITO, is a band-shaped (planar) electrode (solid electrode) in the plan view, and is formed along the sub-pixel line. Further, the opposite electrode 40 is disposed over the center of the sub-pixels adjacent to each other (sub-pixel line) in the horizontal direction. In other words, the opposite electrode 40 continuously covers part of the pixel electrode 20, part of the common electrode 30, and part of the gaps between the pixel electrode 20 and the common electrode 30 (portions where no electrode exists, no-electrode portions) in each sub-pixel. That is, the liquid crystal display device of the present embodiment has pixel electrode portions, common electrode portions, and gap portions between the pixel electrode 20 and the common electrode 30 covered with the opposite electrode 40, and pixel electrode portions, common electrode portions, and gap portions between the pixel electrode 20 and the common electrode 30 not covered with the opposite electrode 40. In addition, the opposite electrode 40 overlaps with the gap between the pixel electrode 20 and the common electrode 30 in the plan view of the substrates 1 and 2.

The opposite electrode 40 is vertically symmetrical in the plan view. Specifically, the opposite electrode 40 is symmetrical about the horizontal center line passing through the center of a sub-pixel in the plan view (the opposite electrode 40 has a rectangular shape in the present embodiment). Further, the pixel electrode portion, the common electrode portion, and the gap portions between the pixel electrode 20 and the common electrode 30 which are covered with the opposite electrode 40 together are also symmetrical about the above center line in the plan view. That is, the opposite electrode 40 equally covers the four domains. In addition, the region covered with the opposite electrode 40 in the first domain, the region covered with the opposite electrode 40 in the second domain, the region covered with the opposite electrode 40 in the third domain, and the region covered with the opposite electrode 40 in the fourth domain have substantially the same area.

Hereinafter, the ratio (percentage) of the area of the opposite electrode 40 in a sub-pixel to the area of the sub-pixel is referred to as the opposite electrode area ratio. Here, the area of the pixel is an area of the region defined by the boundaries with the adjacent pixels. The area of the opposite electrode in a pixel is an area of the region of the opposite electrode defined by the boundaries with the adjacent pixels.

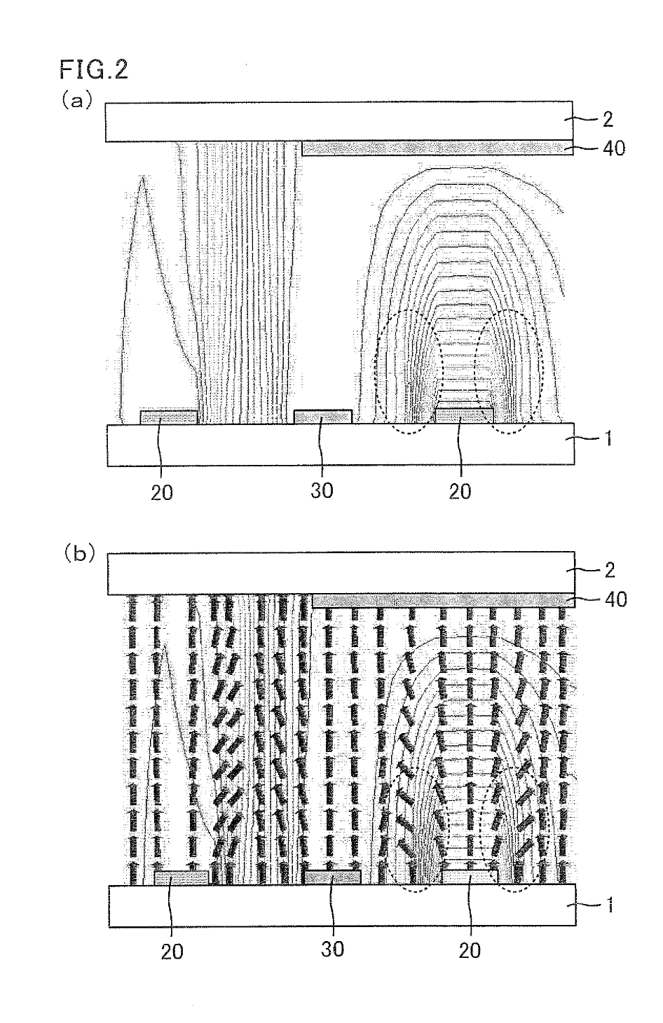

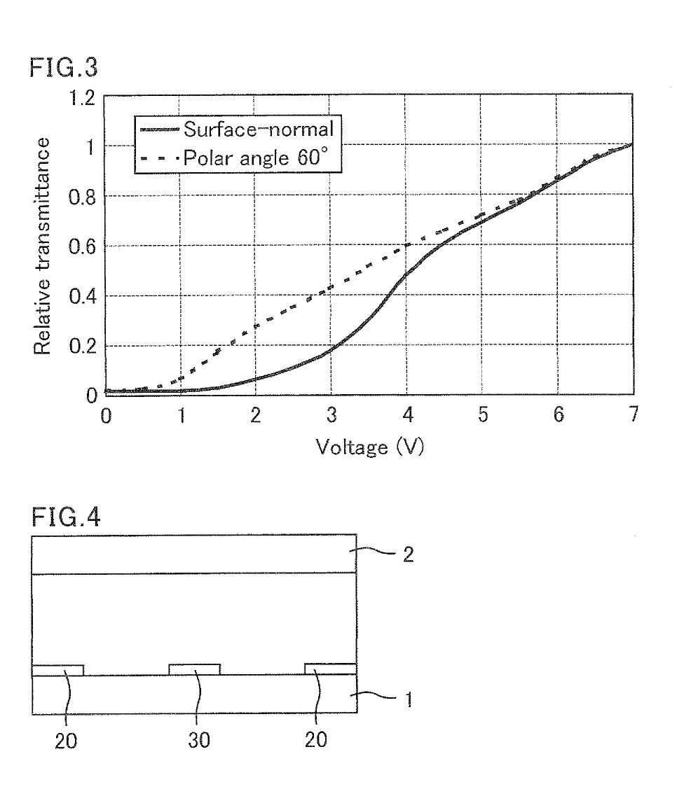

FIG. 2 show the simulation results of the liquid crystal display device of Embodiment 1. FIG. 2(a) shows lines of electric force in the cross-sectional view, and FIG. 2(b) shows the lines of electric force and liquid crystal directors in the cross-sectional view. FIG. 3 shows the VT characteristics of the liquid crystal display device of Embodiment 1 obtained in the simulation. This simulation was performed under the following simulation conditions. Here, the results shown in FIGS. 2(a) and 2(b) are obtained with the electric potential of the pixel electrode 20 of 3.5 V.

### (Simulation Conditions)

L/S=4 μm/7 μm (in other words, L=4 μm and S=7 μm)
Opposite electrode area ratio=50%
dΔn: 350 nm
Δ∈: 20
Disposing a negative C plate monolayer (Retardation Re in in-plane direction: 0 nm, Retardation Rth in surface-normal direction: 150 nm) as an optically compensating plate between the active-matrix substrate 1 and the polarizer 11 and between the opposite substrate 2 and the polarizer 12
Pixel electrode: supplied with an alternating current (AC) voltage (amplitude: 0 to 7 V, frequency: 60 Hz), provided that Vc (electric potential at amplitude center) is set to the same electric potential as the common electrode and the opposite electrode
Common electrode: supplied with a direct current (DC) voltage whose electric potential relative to Vc of the pixel electrode is 0 V
Opposite electrode: supplied with a direct current (DC) voltage whose electric potential relative to Vc of the pixel electrode is 0 V

The mode in which the pixel electrode, the common electrode, and the opposite electrode are supplied with the voltages mentioned above is hereinafter referred to as Applied Voltage Variation 1. The electric potential at the amplitude center means a central potential of the amplitude.

The simulation gives the following results. As shown in FIG. 2(a), the lines of electric force extend in the direction vertical to the surfaces of the substrates 1 and 2 and an electric field (transverse electric field) is generated in the direction parallel to the substrate surfaces between the pixel electrode 20 and the common electrode 30 in the region where the opposite electrode 40 is not disposed. Thus, a bend-shaped electric field is generated in the liquid crystal layer which is in the initial alignment of the homeotropic alignment in this region. As a result shown in FIG. 2(b), two domains are formed whose directors are in directions different from each other by 180°, and the liquid crystal molecules of the nematic liquid crystal material show bend-shaped liquid crystal alignment (bend alignment) in each domain.

On the other hand, as shown in FIG. 2(a), parabolic lines of electric force are generated in the region covered with the opposite electrode 40. Further, the lines of electric force are dense in the vicinity of the pixel electrode 20 covered with the opposite electrode 40 (the region defined by dot lines in FIG. 2(a)). Thus, a slightly distorted bend electric field is formed in this region. As a result shown in FIG. 2(b), two domains are formed whose director directions are different by 180° similarly to the region not covered with the opposite electrode 40, and the liquid crystal molecules of the nematic liquid crystal material show bend-like liquid crystal alignment in each domain. In comparison with the region not covered with the opposite electrode 40, however, lines of electric force are denser in the vicinity of the pixel electrode 20 covered with the opposite electrode 40 (the region defined by dot lines in FIG. 2(b)). Thus, liquid crystal molecules start to tilt with a lower voltage in the region covered with the opposite electrode 40 than in the region not covered with the opposite electrode 40.

Therefore, as shown in FIG. 3, the inclination of the VT characteristic in the surface-normal direction of the substrate surface and the inclination of the VT characteristic in the 0° direction with a polar angle of 60° are made gentle in the liquid crystal display device of the present embodiment.

Further, the opposite electrode 40 is a band-shaped electrode which covers the pixel electrode 20, the common electrode 30, and the gap (no-electrode portion) between the pixel electrode 20 and the common electrode 30 above which the opposite electrode 40 exists (covered with the opposite electrode 40) together in each pixel. Thus, even if multiple panels are produced in accordance with the present embodiment and the active-matrix substrate 1 and the opposite substrate 2 are attached to each other at different degrees among the multiple panels, occurrence of variations (difference) in the VT characteristics among the panels can be reduced.

### Comparative Embodiment 1

FIG. 4 is a schematic cross-sectional view showing the liquid crystal display device of Comparative Embodiment 1.

As shown in FIG. 4, the liquid crystal display device of the present comparative embodiment has the same structure as the liquid crystal display device of Embodiment 1 except that no opposite electrode 40 is disposed on the opposite substrate 2.

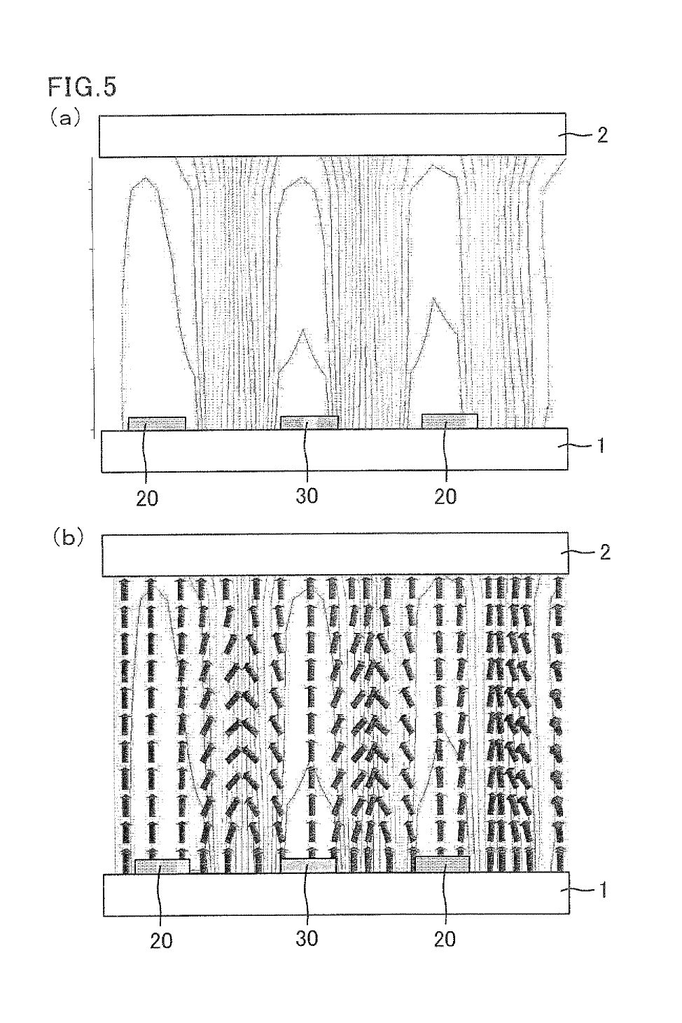

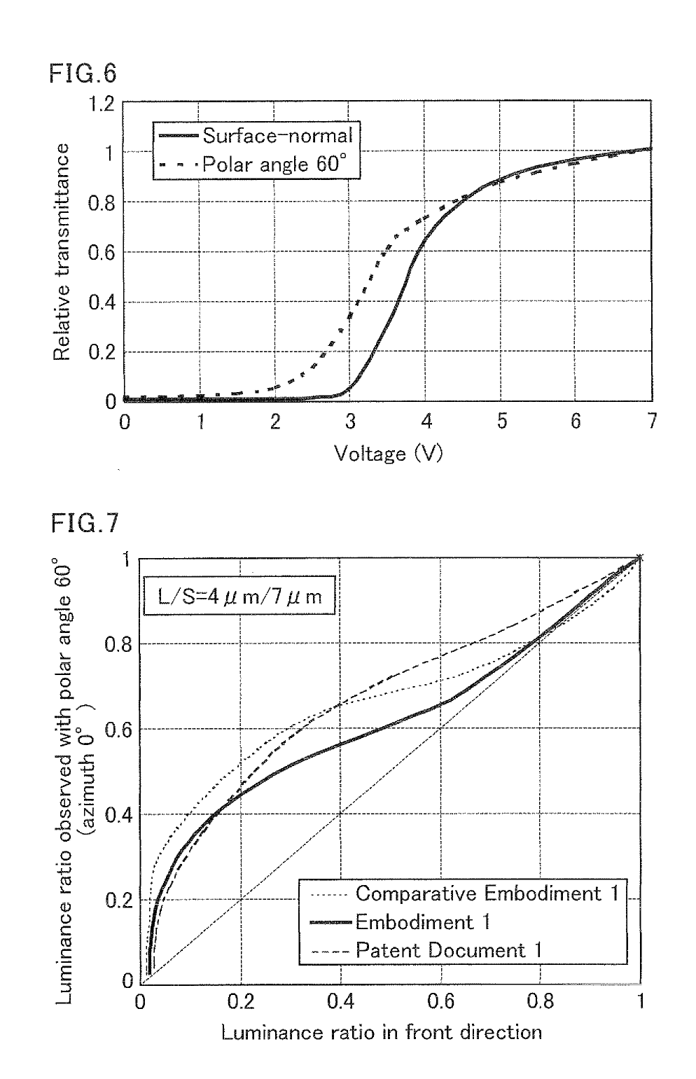

FIG. 5 show the simulation results of the liquid crystal display device of Comparative Embodiment 1; FIG. 5(a) shows lines of electric force in the cross-sectional view, and FIG. 5(b) shows the lines of electric forces and the liquid crystal directors in the cross sectional view. FIG. 6 shows the VT characteristics of the liquid crystal display device of Comparative Embodiment 1 obtained by the simulation. The simulation was performed under the same conditions as the aforementioned simulation conditions except that no opposite electrode 40 is formed on the opposite substrate 2. Further, FIGS. 5(a) and 5(b) show the results with the electric potential of the pixel electrode 20 of 3.5 V.

As shown in FIG. 5(a), the lines of electric force are generated vertically to the surfaces of the substrates 1 and 2, and an electric field in the substrate-surface direction (transverse electric field) occurs between the pixel electrode 20 and the common electrode 30. Thus, a bend-shaped electric field is formed in the liquid crystal layer in a state of initial alignment of homeotropic alignment. As shown in FIG. 5(b), two domains are formed whose director directions are different by 180°, and the liquid crystal molecules of the nematic liquid crystal material show bend-like liquid crystal alignment (bend alignment) in each domain.

Further, as shown in FIG. 6, the inclination of the VT characteristic in the surface-normal direction of the substrate surface and the inclination of the VT characteristic in the 0° direction with a polar angle of 60° are made steep in the liquid crystal display device of the present comparative embodiment.

FIG. 7 shows the comparison result about white-floating (γ shift) between the liquid crystal display devices of Embodiment 1 and Comparative Embodiment 1 based on the aforementioned simulation results. White-floating is evaluated by the tone transmittance ratio of the liquid crystal display device, that is, by comparing the ratio of the luminance observed from the direction with an azimuth of 0° and a polar angle of 60° with the ratio of the luminance in the front direction. Here, the ratio of the luminance in the front direction is a ratio of the luminance in the surface-normal direction of the substrate surface, and the ratio of the luminance is a luminance (relative luminance) on the assumption that the luminance upon displaying a white image (display at 256th tone) is 1. FIG. 7 further shows the simulation result of the liquid crystal display device according to Patent Document 1. In other words, as shown in FIG. 3 of Patent Document 1, the simulation was performed under the same conditions as mentioned above except that the opposite electrode 40 is disposed only on the region opposite to the pixel electrode 20.

As shown in FIG. 7, large white-floating occurs in the liquid crystal display device of Comparative Embodiment 1, particularly at low tones. In the liquid crystal display device of Patent Document 1, white-floating more occurs at high tones while white-floating less occurs at low tones, than in Comparative Embodiment 1. In contrast, in the liquid crystal display device of Embodiment 1, white-floating less occurs at the whole tone, especially at low tones, than in the liquid crystal display device of Comparative Embodiment 1 and the liquid crystal display device according to Patent Document 1.

Further, in the liquid crystal display device of Embodiment 1, the opposite electrode 40 is disposed equally to each domain. Thus, white-floating is reduced in any observing directions.

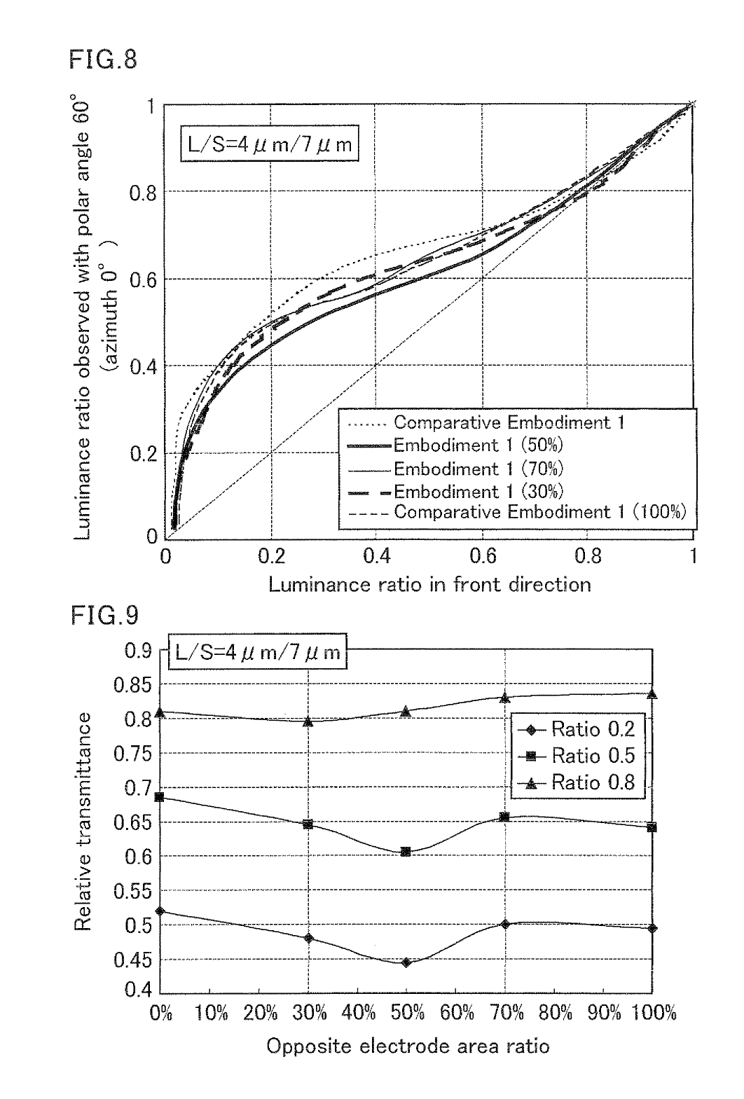

FIG. 8 shows one comparison result about white-floating in the liquid crystal display device of Embodiment 1 and the liquid crystal display device of Comparative Embodiment 1 with variations of the opposite electrode area ratio. The liquid crystal display device of Embodiment 1 is subjected to the simulation under the same conditions as mentioned above except that the opposite electrode area ratio is 30%, 70%, or 100%. Here, the simulation result of the liquid crystal display device of Comparative Embodiment 1 corresponds to the result with an opposite electrode area ratio=0%, and the result with an opposite electrode area ratio=100% corresponds to the result of the liquid crystal display device in which the whole sub-pixel region is covered with the opposite electrode 40 (comparative embodiment). FIG. 9 shows the dependence between the effect of reducing white-floating and the opposite electrode area ratio (front luminance ratio: 0.2, 0.5, or 0.8).

The result shows that white-floating is most reduced with an opposite electrode area ratio of 50%. The result also shows that white-floating is effectively reduced with an opposite electrode area ratio of 30 to 70% (more preferably 40 to 60%, and particularly preferably 45 to 55%).

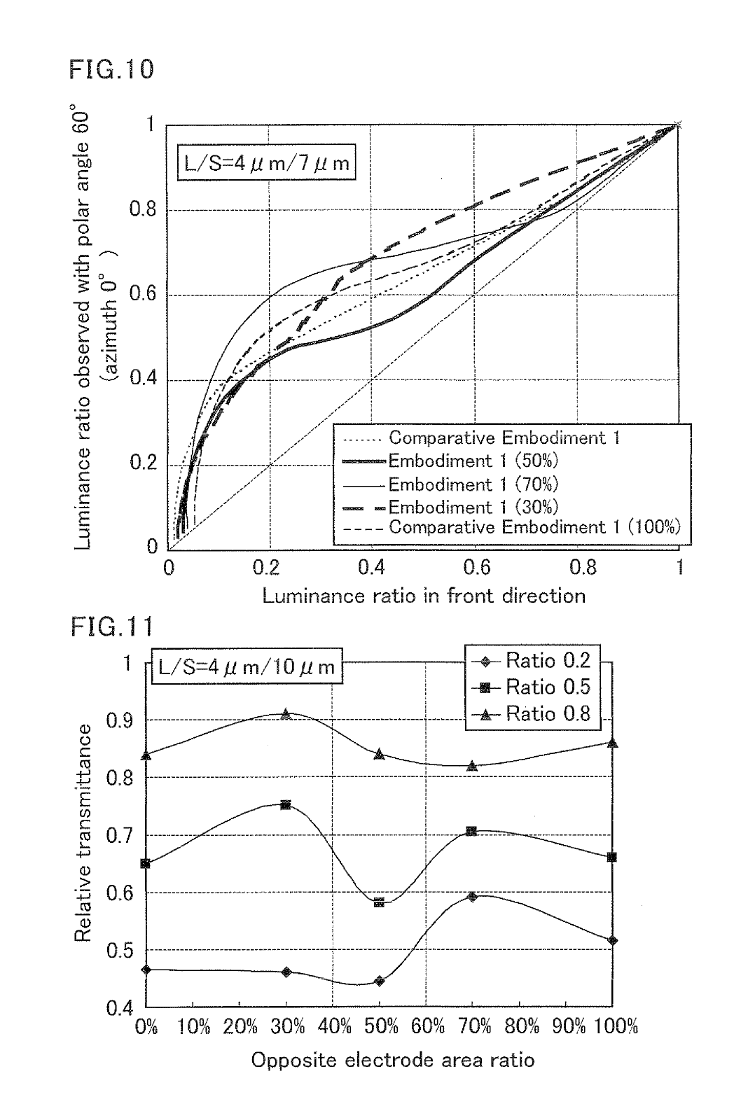

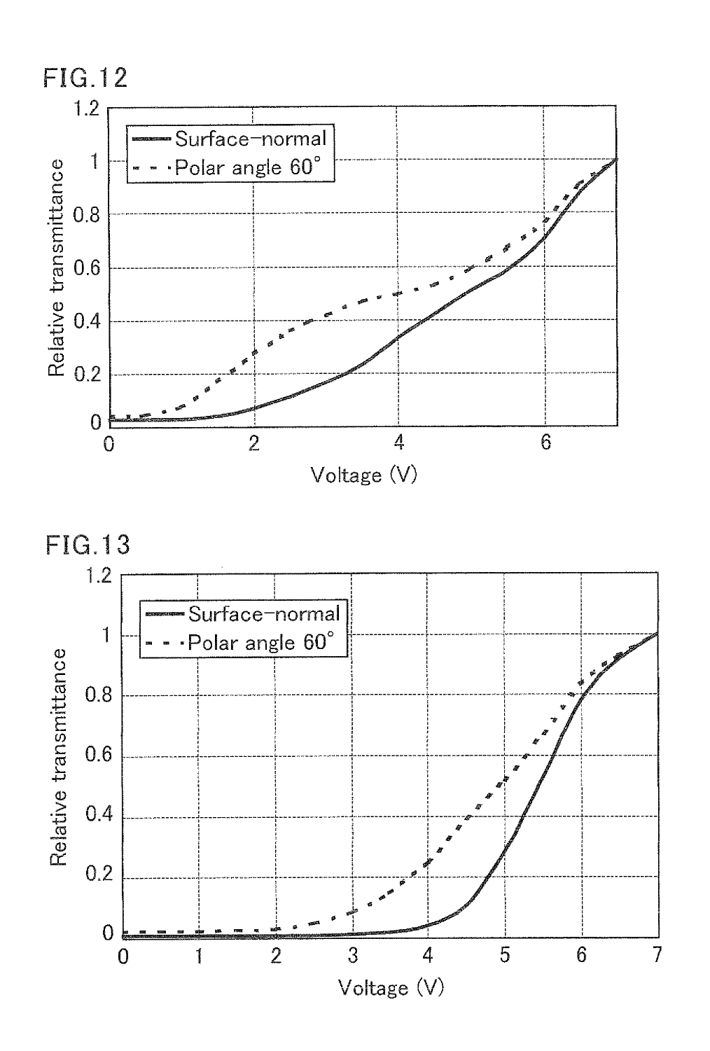

FIG. 10 shows another comparison result about white-floating in the liquid crystal display device of Embodiment 1 and the liquid crystal display device of Comparative Embodiment 1 with variations of the opposite electrode area ratio. The simulation is performed under the same simulation conditions as mentioned above except that L/S is 4 μm/10 μm and the opposite electrode area ratio is 0%, 30%, 50%, 70%, or 100%. FIG. 11 shows the dependence between the effect of reducing white-floating and the opposite electrode area ratio (front luminance ratio: 0.2, 0.5, or 0.8). FIG. 12 shows the VT characteristics of the liquid crystal display device of Embodiment 1 (opposite electrode area ratio=50%, L/S=4 μm/10 μm) obtained in the simulation. FIG. 13 shows the VT characteristics of the liquid crystal display device of Comparative Embodiment 1 (opposite electrode area ratio=0%, L/S=4 μm/10 μm) obtained in the simulation.

The result shows that white-floating is most reduced with an opposite electrode area ratio of 50% even in the case of widening the spacing S between the pixel electrode 20 and the common electrode 30. The result also shows that white-floating is reduced at halftones with an opposite electrode area ratio of 40 to 60% (more preferably, 45 to 55%).

As shown in FIGS. 12 and 13, a widened spacing S between the pixel electrode 20 and the common electrode 30 leads to slightly mild inclination of the VT characteristic in the surface-normal direction and of the VT characteristic in the 0° direction with a polar angle of 60° even in Comparative Embodiment 1. However, both of the inclinations in the liquid crystal display device of Embodiment 1 with an opposite electrode area ratio of 50% are milder than those in Comparative Embodiment 1; thus, the aforementioned results are obtained, probably.

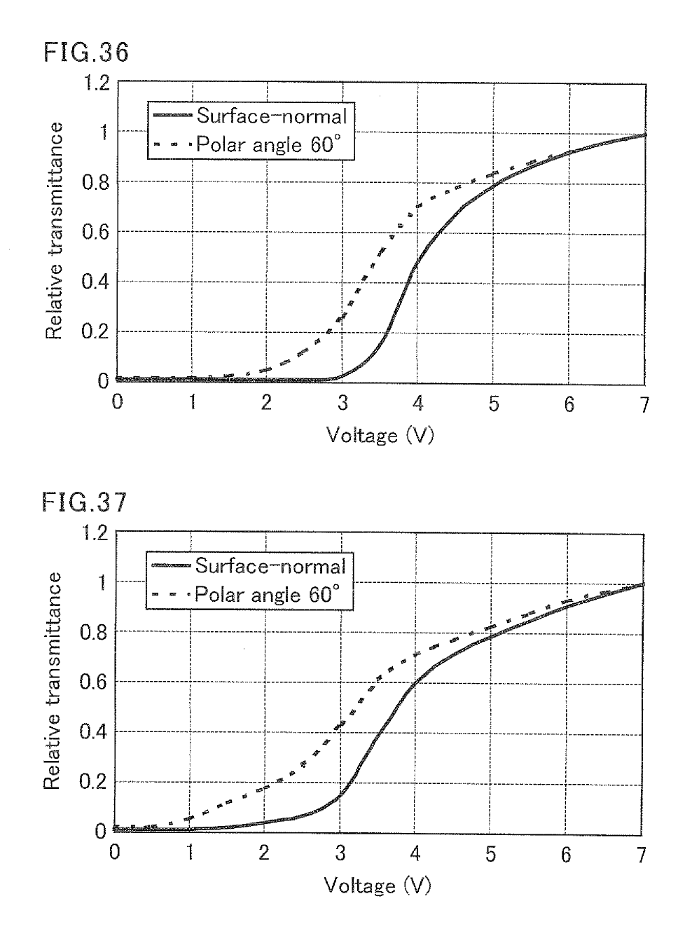

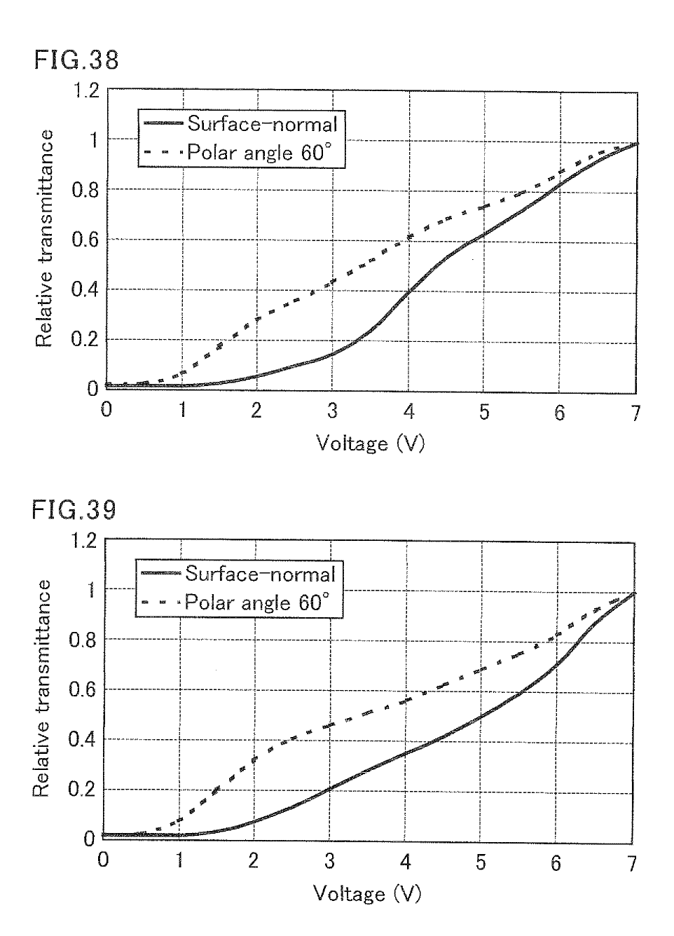

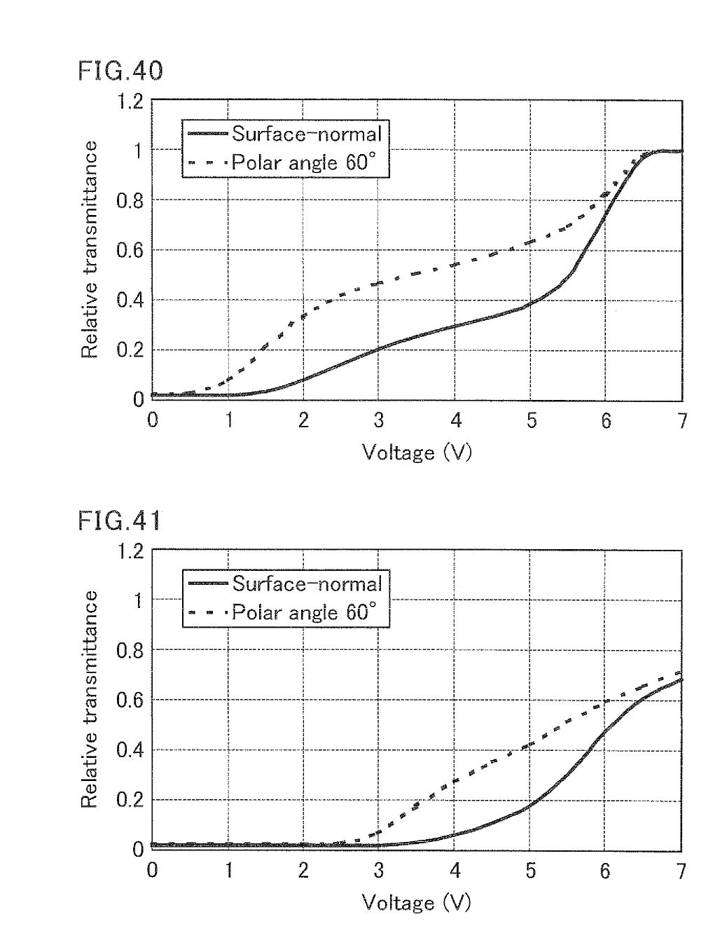

FIG. 35 shows still another comparison result about white-floating in the liquid crystal display device of Embodiment 1 and the liquid crystal display device of Comparative Embodiment 1 with variations of the opposite electrode area ratio. The simulation was performed under the same conditions as mentioned above except that L/S is 2 μm/7 μm and the opposite electrode area ratio is 0%, 30%, 50%, 70%, or 100%. FIG. 36 shows the VT characteristics of the liquid crystal display device of Comparative Embodiment 1 (opposite electrode area ratio=0%, L/S=2 μm/7 μm) obtained in the simulation. FIG. 37 shows the VT characteristics of the liquid crystal display device of Embodiment 1 (opposite electrode area ratio=30%, L/S=2 μm/7 μm) obtained in the simulation. FIG. 38 shows the VT characteristics of the liquid crystal display device of Embodiment 1 (opposite electrode area ratio=50%, L/S=2 μm/7 μm) obtained in the simulation. FIG. 39 shows the VT characteristics of the liquid crystal display device of Embodiment 1 (opposite electrode area ratio=70%, L/S=2 μm/7 μm) obtained in the simulation. FIG. 40 shows the VT characteristics of the liquid crystal display device of Comparative Embodiment (opposite electrode area ratio=100%, L/S=2 μm/7 μm) obtained in the simulation.

The result shows that white-floating is reduced with an opposite electrode area ratio of 30 to 70% even in the case of reducing the line width L between the pixel electrode 20 and the common electrode 30.

As shown in FIG. 36, a reduced line width L leads to slightly mild inclination of the VT characteristic in the surface-normal direction and of the VT characteristic in the 0° direction with a polar angle of 60° even in Comparative Embodiment 1. As shown in FIGS. 37 to 39, however, both of the inclinations of the liquid crystal display device of Embodiment 1 with an opposite electrode area ratio of 30 to 70% are milder than those in Comparative Embodiment 1; thus, the aforementioned result was obtained, probably. In the case of L/S=2 μm/7 μm, white-floating is reduced in the liquid crystal display device of Comparative Embodiment with an opposite electrode area ratio of 100%.

The following will show how the effect of reducing white-floating changes in the case that the voltage applied to the common electrode 30 and the opposite electrode 40 is changed in the liquid crystal display device of Embodiment 1. Here, the pixel electrode 20 is supplied with an AC voltage (amplitude: 0 to 7 V, frequency: 60 Hz, Vc: the same electric potential as the common electrode 30 and the opposite electrode 40). The following will show the applied voltage variations for the liquid crystal display device of Embodiment 1.

### (Applied Voltage Variation 2)

Except that the common electrode 30 is supplied with ±DC voltage, the simulation was performed under the same simulation conditions as mentioned above.

### (Applied Voltage Variation 3)

Except that the opposite electrode 40 is supplied with ±DC voltage (specifically, a DC voltage having a comparative electric potential to the Vc of the pixel electrode of +1 V), the simulation was performed under the same simulation conditions as mentioned above.

### (Applied Voltage Variation 4)

Except that the common electrode 30 is supplied with an AC voltage (amplitude: 0 to 7 V, frequency: 60 Hz, Vc: the same electric potential as the pixel electrode 20 and the opposite electrode 40) with a reverse phase of the AC voltage applied to the pixel electrode 20, the simulation was performed under the same simulation conditions as mentioned above.

### (Applied Voltage Variation 5)

Except that the opposite electrode 40 is supplied with an AC voltage (amplitude: 0 to 7 V, frequency: 60 Hz, Vc: the same electric potential as the pixel electrode 20 and the common electrode 30) with a reverse phase of the AC voltage applied to the pixel electrode 20, the simulation was performed under the same simulation conditions as mentioned above.

### (Applied Voltage Variation 6)

Except that the common electrode 30 is supplied with an AC voltage (amplitude: 0 to 7 V, frequency: 60 Hz, Vc: the same electric potential as the pixel electrode 20 and the opposite electrode 40) with the same phase as the AC voltage applied to the pixel electrode 20, the simulation was performed under the same simulation conditions as mentioned above.

### (Applied Voltage Variation 7)

Except that the opposite electrode 40 is supplied with an AC voltage (amplitude: 0 to 7 V, frequency: 60 Hz, Vc: the same electric potential as the pixel electrode 20 and the common electrode 30) with the same phase as the AC voltage applied to the pixel electrode 20, the simulation was performed under the same simulation conditions as mentioned above.

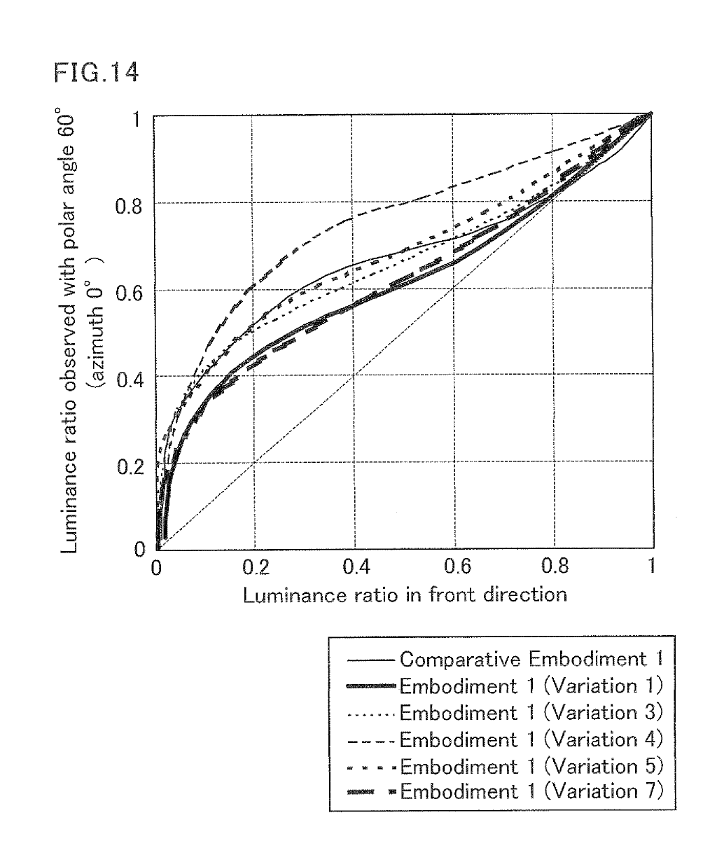

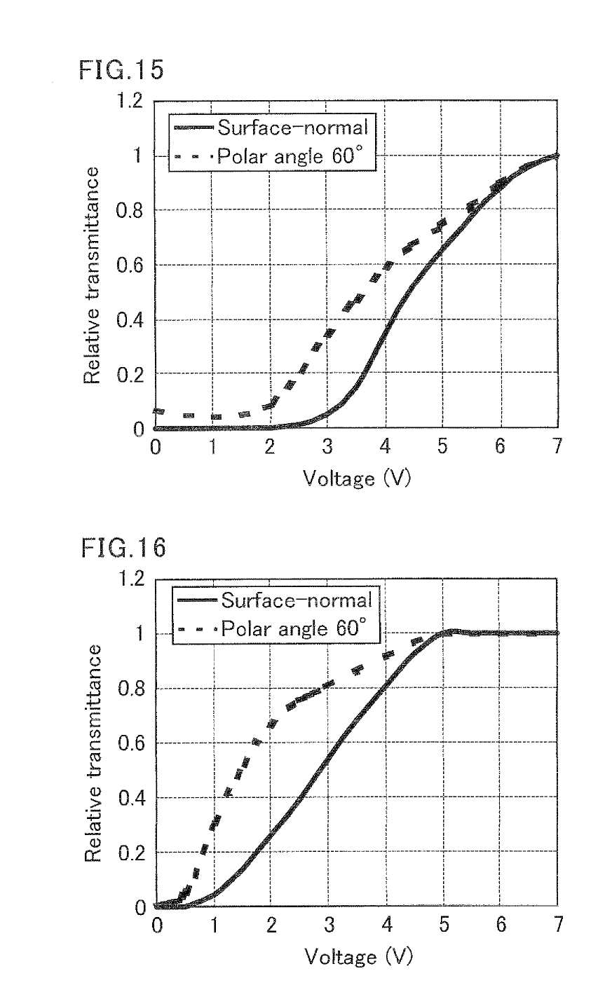

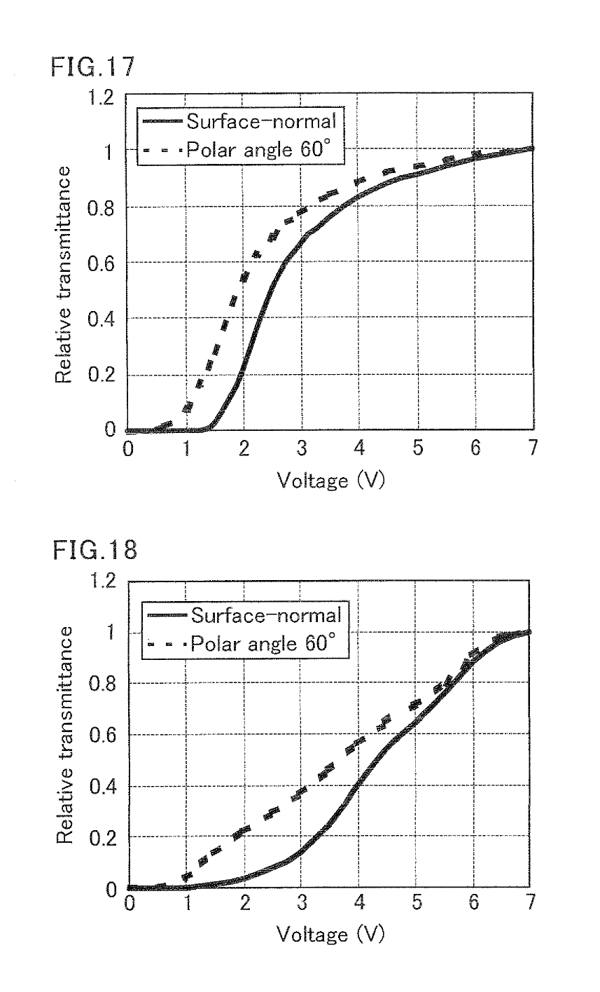

FIG. 14 shows the comparison result about white-floating in the liquid crystal display device of Embodiment 1 and the liquid crystal display device of Comparative Embodiment 1 with each of the applied voltage variations. FIG. 15 shows the VT characteristics of the liquid crystal display device of Embodiment 1 (Applied Voltage Variation 3) obtained in the simulation. FIG. 16 shows the VT characteristics of the liquid crystal display device of Embodiment 1 (Applied Voltage Variation 4) obtained in the simulation. FIG. 17 shows the VT characteristics of the liquid crystal display device of Embodiment 1 (Applied Voltage Variation 5) obtained in the simulation. FIG. 41 shows the VT characteristics of the liquid crystal display device of Embodiment 1 (Applied Voltage Variation 6) obtained in the simulation. FIG. 18 shows the VT characteristics of the liquid crystal display device of Embodiment 1 (Applied Voltage Variation 7) obtained in the simulation. Table 1 shows the evaluation results for each of the applied voltage variations. In Table 1, the electric potential of DC is a comparative electric potential to Vc of the pixel electrode. Further, in Table 1, “Pix” means a pixel electrode, “Com” means a common electrode, and “Opp” means an opposite electrode.

TABLE 1

| | Variation 1 | Variation 2 | Variation 3 | Variation 4 | Variation 5 | Variation 6 | Variation 7 |
|---|---|---|---|---|---|---|---|
| Pixel | AC | AC | AC | AC | AC | AC | AC |
| electrode | Vc: the same | | | | | | |
| | electric potential as | | | | | | |
| | Com, Opp | | | | | | |
| Opposite | DC0V | DC0V | ±DC | DC0V | AC | DC0V | AC |
| electrode | | | | | reverse phase of | | the same phase as |
| | | | | | drain | | drain |
| | | | | | Vc: the same | | Vc: the same |
| | | | | | electric potential as | | electric potential as |
| | | | | | Com, Pix | | Com, Pix |
| Common | DC0V | ±DC | DC0V | AC | DC0V | AC | DC0V |
| electrode | | | | reverse phase of | | the same phase as | |
| | | | | drain | | drain | |
| | | | | Vc: the same | | Vc: the same | |
| | | | | electric potential as | | electric potential as | |
| | | | | Pix, Opp | | Pix, Opp | |
| Practicality | + | − | − | − | − | ± | + |

In Applied Voltage Variation 2, a DC voltage is applied to the liquid crystal layer 3 even when no voltage is applied to the pixel electrode 20. Thus, problems such as liquid crystal degradation and screen burn-in may occur, and Applied Voltage Variation 2 leads to low practicality. In Applied Voltage Variations 3 and 5, white-floating is not sufficiently reduced. Thus, Applied Voltage Variations 3 and 5 lead to low practicality. In Applied Voltage Variation 4, white-floating is not reduced. Thus, Applied Voltage Variation 4 leads to very low practicality. In Applied Voltage Variation 6, white-floating is reduced; however, a voltage applied to the liquid crystal layer 3 is lower than the electric potential of the pixel electrode 20, and the driving voltage is high. Thus, Applied Voltage Variation 6 does not lead to very high practicality. Particularly in Applied Voltage Variation 7, white-floating is reduced and no other problems occur; thus, Applied Voltage Variation 6 leads to very high practicality similarly to the aforementioned Applied Voltage Variation 1.

### Embodiment 2

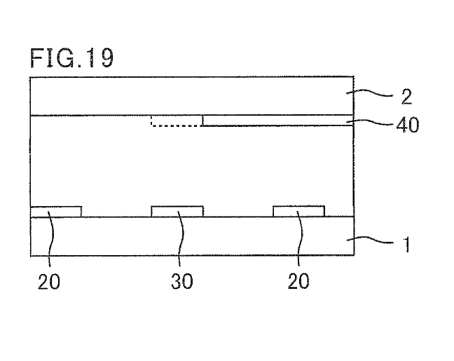

FIG. 19 is a schematic cross-sectional view showing the liquid crystal display device of Embodiment 2.

As shown in FIG. 19, the liquid crystal display device of the present embodiment has the same structure as the liquid crystal display device of Embodiment 1 except that no opposite electrode 40 is disposed above the common electrode 30. In other words, the opposite electrode 40 at the region over the common electrode 30 is deleted in the plan view of the liquid crystal display panel 100.

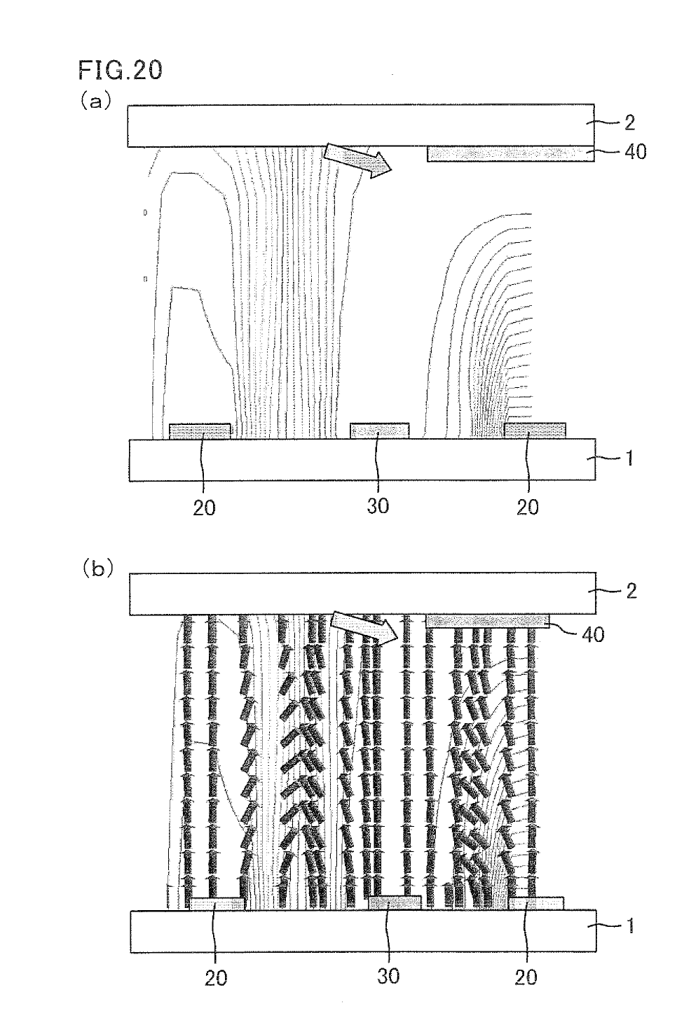

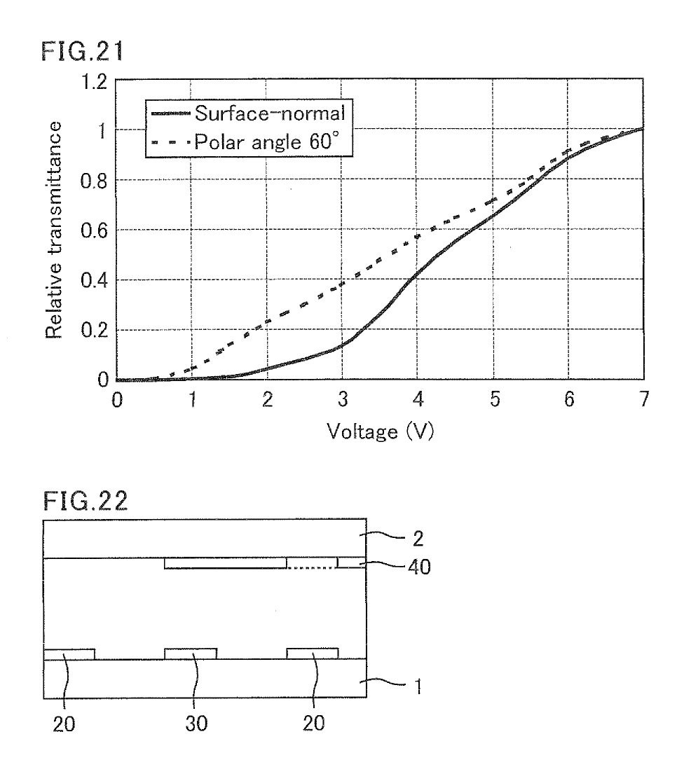

FIG. 20 show the simulation results of the liquid crystal display device of Embodiment 2; FIG. 20(a) shows lines of electric force in the cross-sectional view, and FIG. 20(b) shows the lines of electric force and liquid crystal directors in the cross-sectional view. FIG. 21 shows the VT characteristics of the liquid crystal display device of Embodiment 2 obtained in the simulation. This simulation was performed under the same conditions as mentioned above except that no opposite electrode 40 is disposed above the common electrode 30. In other words, the opposite electrode area ratio is reduced as the result of extraction (removal) of the opposite electrode 40. FIGS. 20(a) and 20(b) show the results with the electric potential of the pixel electrode 20 of 3.5 V.

As shown by arrows in FIGS. 20(a) and 20(b), the lines of electric force slightly shift toward the region where the opposite electrode 40 is removed in comparison with Embodiment 1. As shown in FIG. 21, however, the inclination of the VT characteristic in the surface-normal direction of the substrate surface and the inclination of the VT characteristic in the 0° direction with a polar angle of 60° are the same as in Embodiment 1.

### Embodiment 3

FIG. 22 is a schematic cross-sectional view showing the liquid crystal display device of Embodiment 3.

As shown in FIG. 22, the liquid crystal display device of the present embodiment has the same structure as the liquid crystal display device of Embodiment 1 except that no opposite electrode 40 is disposed above the pixel electrode 20. in other words, the opposite electrode 40 at the region over the pixel electrode 20 is deleted in the plan view of the liquid crystal display panel 100.

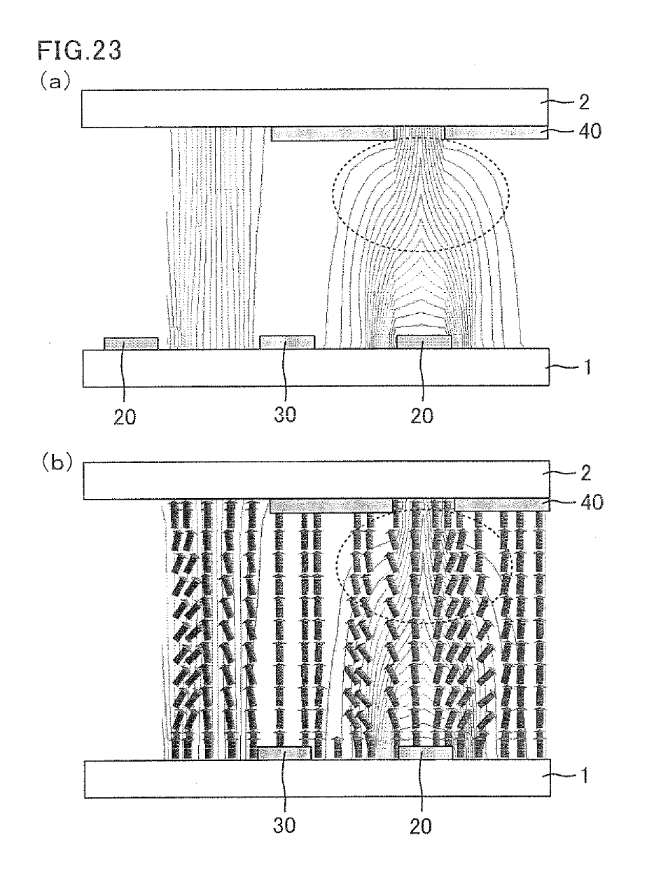

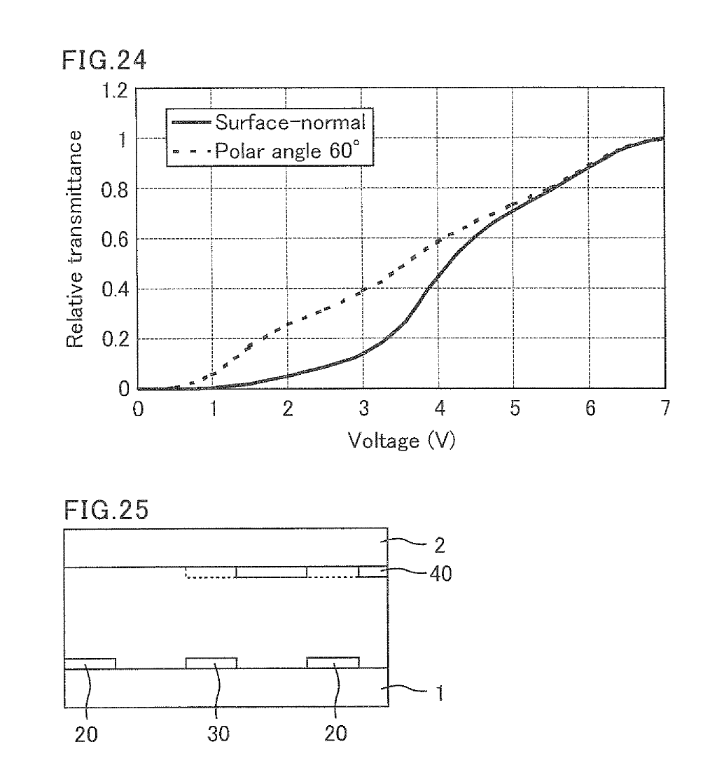

FIG. 23 show the simulation results of the liquid crystal display device of Embodiment 3; FIG. 23(a) shows lines of electric force in the cross-sectional view, and FIG. 23(b) shows the lines of electric force and liquid crystal directors in the cross-sectional view. FIG. 24 shows the VT characteristics of the liquid crystal display device of Embodiment 3 obtained in the simulation. This simulation was performed under the same conditions as mentioned above except that no opposite electrode 40 is disposed above the pixel electrode 20. In other words, the opposite electrode area ratio is reduced as the result of extraction (removal) of the opposite electrode 40. FIGS. 23(a) and 23(b) show the result with the electric potential of the pixel electrode 20 of 3.5 V.

As shown in FIG. 23(a), removal of the opposite electrode 40 above the pixel electrode 20 leads to widening of the region with the dense lines of electric force toward the vicinity of the opposite substrate 2 (region defined by dot lines in FIG. 23) in comparison with Embodiment 1. As shown in FIG. 23(b), the liquid crystal molecules start to tilt in the vicinity of the opposite substrate 2 even with a low applied voltage. In other words, the region where liquid crystal molecules start to tilt even when an applied voltage is low is widened toward the opposite substrate 2. On the other hand, the inclination angle thereof is milder (smaller) than in Embodiment 1. As the result shown in FIG. 24, the inclination of the VT characteristic in the surface-normal direction of the substrate surface and the inclination of the VT characteristic in the 0° direction with a polar angle of 60° are slightly different from those in Embodiment 1.

### Embodiment 4

FIG. 25 is a schematic cross-sectional view showing the liquid crystal display device of Embodiment 4.

As shown in FIG. 25, the liquid crystal display device of the present embodiment has the same structure as the liquid crystal display device of Embodiment 1 except that no opposite electrode 40 is disposed above the common electrode 30 and the pixel electrode 20. In other words, the opposite electrode 40 at the region over the pixel electrode 20 and the common electrode 30 is deleted in the plan view of the liquid crystal display panel 100, and the liquid crystal display device of the present embodiment has a combination structure of Embodiment 2 and Embodiment 3.

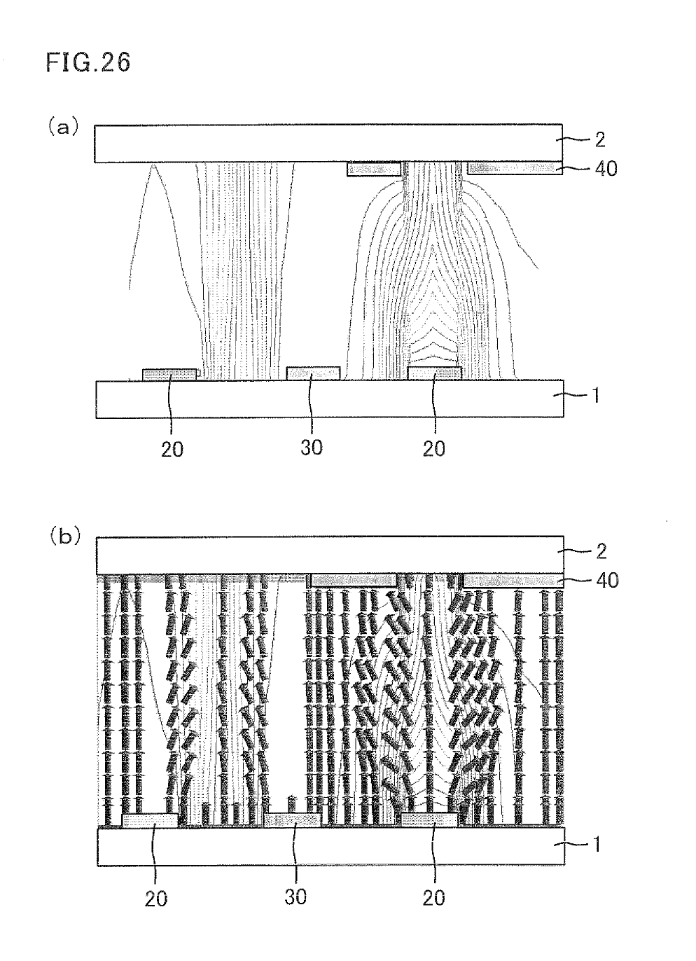

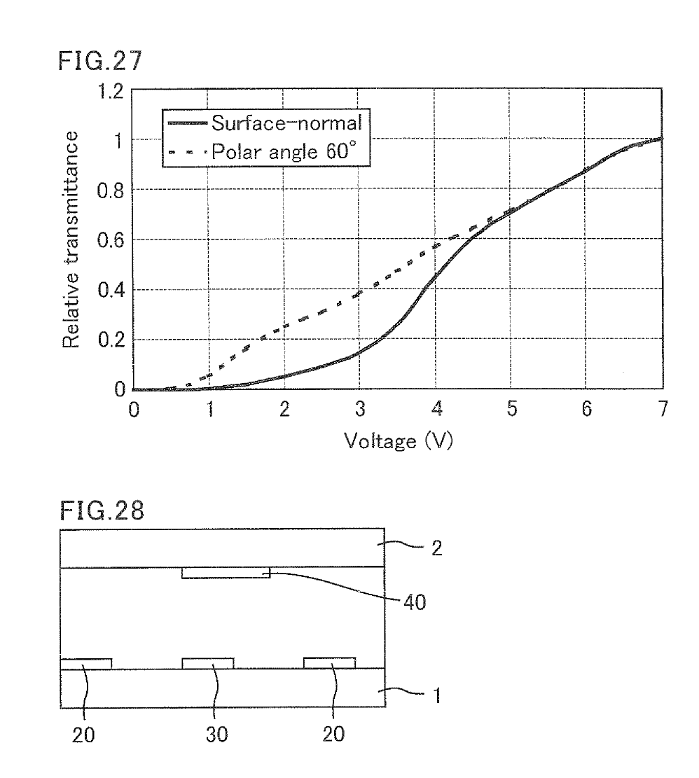

FIG. 26 shows the simulation result of the liquid crystal display device of Embodiment 4; FIG. 26(a) shows lines of electric force in the cross-sectional view, and FIG. 26(b) shows the lines of electric force and liquid crystal director in the cross-sectional view. FIG. 27 shows the VT characteristics of the liquid crystal display device of Embodiment 4 obtained in the simulation. This simulation was performed in the same simulation conditions as mentioned above except that no opposite electrode 40 is disposed above the pixel electrode 20 and the common electrode 30. In other words, the opposite electrode area ratio is reduced as the result of extraction (removal) of the opposite electrode 40. FIGS. 26(a) and 26(b) show the result with the electric potential of the pixel electrode 20 of 3.5 V.

As shown in FIG. 26(a), the distributed lines of electric force are the sum of the lines of electric force in Embodiment 2 and Embodiment 3. As shown in FIG. 26(b), the region where liquid crystal molecules start to tilt even with a low applied voltage is widened toward the opposite substrate 2. On the other hand, the inclination angle thereof is milder (smaller) than in Embodiment 1. As a result shown in FIG. 27, the inclination of the VT characteristic in the surface-normal direction of the substrate surface and the inclination of the VT characteristic in the 0° direction with a polar angle of 60° are slightly different from those in Embodiment 1.

### Embodiment 5

FIG. 28 is a schematic cross-sectional view showing the liquid crystal display device of Embodiment 5.

As shown in FIG. 28, the liquid crystal display device of the present embodiment has the same structure as the liquid crystal display device of Embodiment 1 except that the opposite electrode 40 above the pixel electrode 20 is extracted (removed) and the width of the region with the opposite electrode 40 extracted therefrom is wider than the width of the pixel electrode 20. In other words, the opposite electrode 40 at the region over the pixel electrode 20 is deleted and the opposite electrode 40 is also deleted from the region over the pixel electrode 20 to the region apart from the pixel electrode 20 by a distance of 3.5 μm toward the common electrode 30, in the plan view of the liquid crystal display panel 100. Since the spacing S in the present embodiment is 7 μm similarly to Embodiment 1, the opposite electrode 40 is removed to the center line of the gap between the pixel electrode 20 and the common electrode 30. That is, the opposite electrode 40 is disposed apart from the pixel electrode 20 in the plan view of the liquid crystal display panel 100 in the liquid crystal display device of the present embodiment.

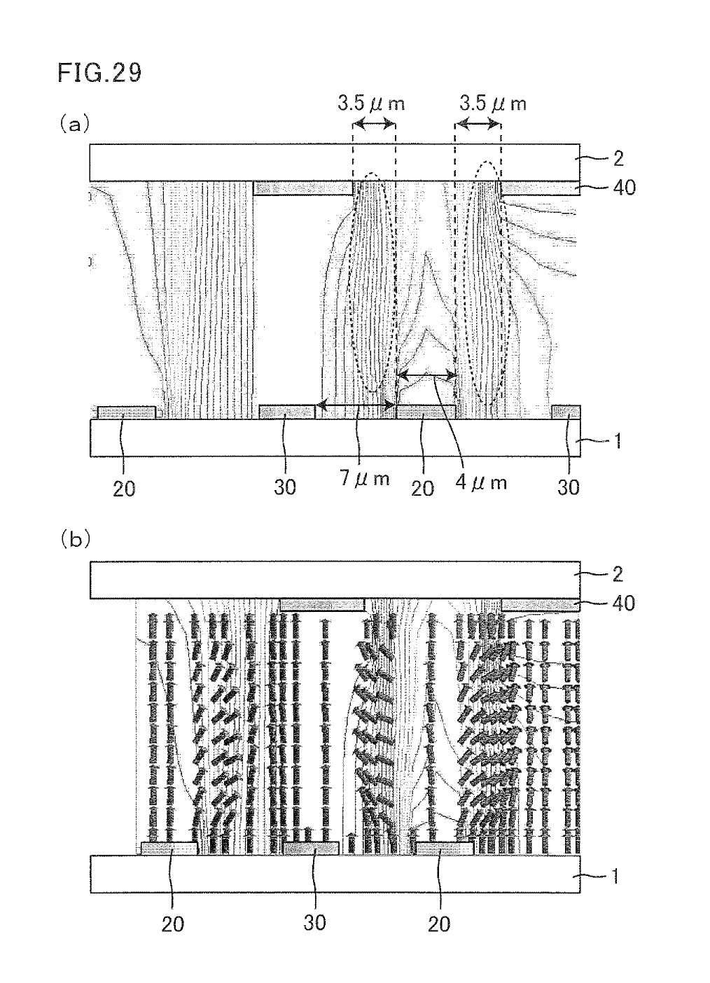

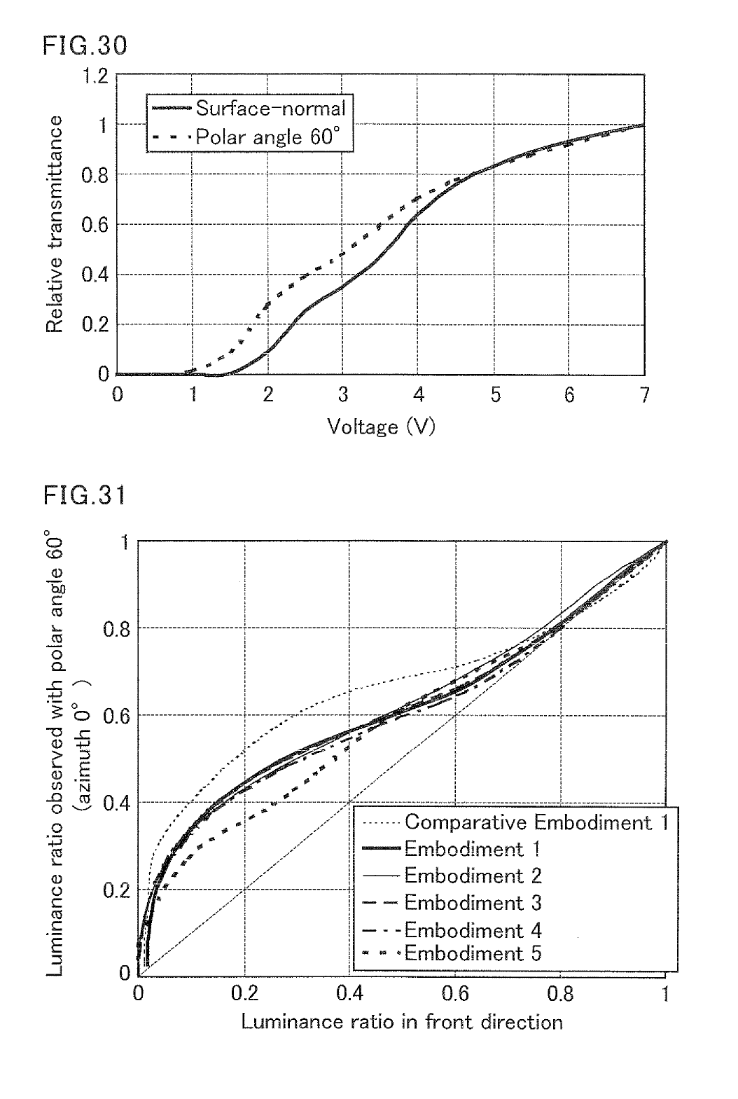

FIG. 29 show the simulation results of the liquid crystal display device of Embodiment 5; FIG. 29(a) shows lines of electric force in the cross-sectional view, and FIG. 29(b) shows the lines of electric force and liquid crystal directors in the cross-sectional view. FIG. 30 shows the VT characteristics of the liquid crystal display device of Embodiment 5 obtained in the simulation. The simulation was performed under the same simulation conditions as mentioned above except that no opposite electrode 40 is disposed above the pixel electrode 20 and that no opposite electrode 40 is disposed from the region over the pixel electrode 20 to the region apart from the pixel electrode 20 by a distance of 3.5 μm toward the common electrode 30. In other words, the opposite electrode area ratio is reduced as the result of extraction (removal) of the opposite electrode 40. FIGS. 29(a) and 29(b) show the results with the electric potential of the pixel electrode 20 of 3.5 V.

As a result shown in FIG. 29(a), the dense lines of electric force in the vicinity of the pixel electrode 20 (region defined by dot lines in FIG. 29(a)) is elongated in the surface-normal direction of the substrate surface. As shown in FIG. 29(b), liquid crystal molecules start to tilt even when an applied voltage is low in the vicinity of the opposite substrate 2, and the region where liquid crystal molecules start to tilt even with a low applied voltage is extended toward the opposite substrate 2. Further, the inclination angle thereof does not become mild. In other words, the inclination angle is not reduced. Thus, as shown in FIG. 30, the inclination of the VT characteristics is less dependent on a polar angle.

FIG. 31 shows the comparison result about white-floating in the liquid crystal display devices of Embodiments 1 to 5 and Comparative Embodiment 1 based the aforementioned simulation results. As shown in FIG. 31, white-floating is reduced as long as the opposite electrode 40 is removed from any position above the electrodes (pixel electrode 20 and/or common electrode 30) on the TFT-array substrate 1. This is presumably because the position of removing the opposite electrode 40 from the region above the electrode(s) on the TFT-array substrate 1 does not cause great change in the lines of electric force generated around the pixel electrode 20 when a voltage is applied. In addition, partial removal of the opposite electrode 40 from a position above the electrode (pixel electrode 20 and/or common electrode 30) on the TFT-array substrate 1, as in Embodiments 2 to 4, causes slightly better reduction in white-floating than in Embodiment 1.

In Embodiment 5, white-floating is further reduced than in Embodiments 1 to 4. This is because, in the liquid crystal display device of Embodiment 5, white-floating is not reduced owing to the mild inclination of the VT characteristics as in the liquid crystal display devices of Embodiments 1 to 4, but is reduced owing to formation of multiple VT regions each having a different threshold value (regions each showing different VT characteristics) in a sub-pixel. In other words, the device of Embodiment 5 presumably achieves the same effect as an MVA-mode device having multiple pixels.

### Comparative Embodiment 2

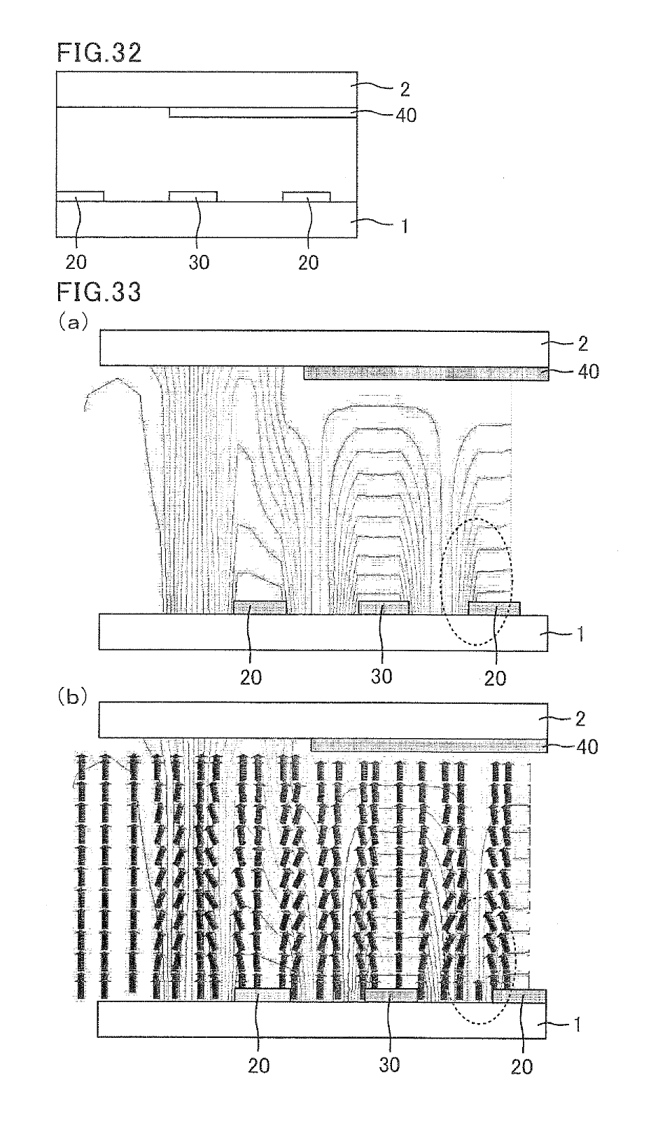

FIG. 32 is a schematic cross-sectional view showing the liquid crystal display device of Comparative Embodiment 2.

As shown in FIG. 32, the liquid crystal display device of the present comparative embodiment has the same structure as the liquid crystal display device of Embodiment 1 except that the opposite electrode 40 is not supplied with a predetermined electric potential and the electric potential of the opposite electrode 40 is set to an electrically floating (insulated) state.

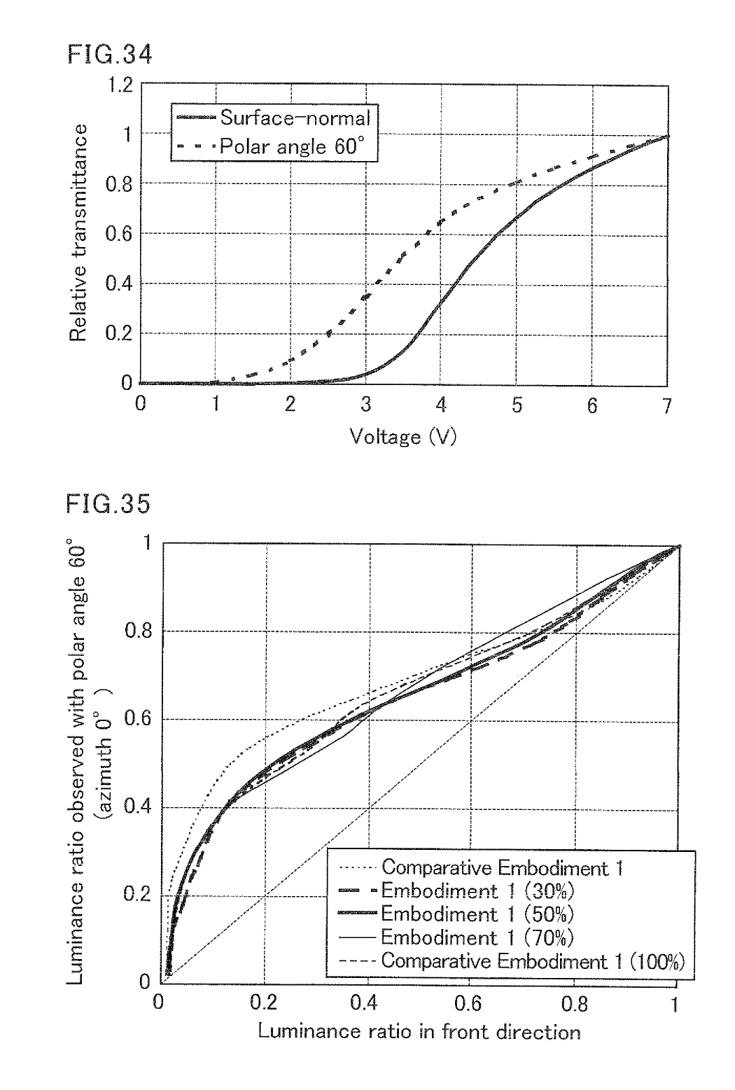

FIG. 33 show the simulation results of the liquid crystal display. device of Comparative Embodiment 2; FIG. 33(a) shows lines of electric force in the cross-sectional view, and FIG. 33(b) shows the lines of electric force and liquid crystal directors in the cross-sectional view. FIG. 34 shows the VT characteristics of the liquid crystal display device of Comparative Embodiment 2 obtained in the simulation. The simulation was performed under the same simulation conditions as mentioned above except that the electric potential of the opposite electrode 40 is set to a floating state. FIGS. 33(a) and 33(b) show the results with the electric potential of the pixel electrode 20 of 3.5 V.

As a result shown in FIG. 33(a), parabolic lines of electric force are generated in the region covered with the opposite electrode 40. Further, the lines of electric force are denser in the vicinity of the pixel electrode 20 (region defined by dot lines in FIG. 33(a)) covered with the opposite electrode 40 than in the liquid crystal display device of Comparative Embodiment 1, but are not denser than in the liquid crystal display device of Embodiment 1. As a result shown in FIG. 33(b), liquid crystal molecules start to tilt with a lower applied voltage in the region where the lines of electric force are dense (region defined by dot lines in FIG. 33(b)) in the vicinity of the pixel electrode 20 covered. with the opposite electrode 40 than in the region where no opposite electrode 40 is disposed. However, the liquid crystal molecules are not as greatly tilted as in the liquid crystal display device of Embodiment 1.

Therefore, as shown in FIG. 34, the inclination of the VT characteristic in the surface-normal direction of the substrate surface and the inclination of the VT characteristic in the 0° direction with a polar angle of 60° are slightly mild in the liquid crystal display device of the present comparative embodiment, but white-floating is not reduced.

The present application claims priority to Patent Application No. 2008-259985 filed in Japan on Oct. 6, 2008 under the Paris Convention and provisions of national law in a designated State. The entire contents of which are hereby incorporated by reference.

### EXPLANATION OF SYMBOLS

100: Liquid crystal display panel
1: Active-matrix substrate (TFT-array substrate)
2: Opposite substrate
3: Liquid crystal layer
11, 12: Polarizer
11a, 12a: Absorption axis
20: Pixel electrode
21: Trunk portion
22: Branch portion
30: Common electrode
31: Trunk portion
32: Branch portion
40: Opposite electrode

1. A liquid crystal display device, comprising:
a first substrate and a second substrate disposed opposite to each other; and
a liquid crystal layer between the first substrate and the second substrate, the first substrate having a first comb-shaped electrode and a second comb-shaped electrode,
the first electrode and the second electrode being planarly disposed opposite to each other in a pixel,
the second substrate having a third electrode which is partially disposed in the pixel and is configured to be supplied with a predetermined electric potential,
the liquid crystal layer including a p-nematic liquid crystal which is configured to be aligned perpendicularly to substrate surfaces of the first substrate and the second substrate when no voltage is applied, and
in the plan view of the first substrate and the second substrate, the liquid crystal display device having a first gap and a second gap between the first electrode and the second electrode, the first gap being covered with the third electrode and the second gap not being covered with the third electrode.

2. The liquid crystal display device according to claim 1,
wherein the third electrode is a belt-shaped electrode which covers the first electrode, the second electrode, and the first gap together in the pixel.

3. The liquid crystal display device according to claim 2,
wherein a ratio of an area of the third electrode in the pixel is not smaller than 30% and not larger than 70% to an area of the pixel.

4. The liquid crystal display device according to claim 1,
wherein one of the first electrode and the second electrode is a pixel electrode,
the other of the first electrode and the second electrode is a common electrode, and
the third electrode is disposed apart from the pixel electrode in the plan view of the first substrate and the second substrate.

5. The liquid crystal display device according to claim 1,
wherein one of the first electrode and the second electrode is a pixel electrode which is configured to be supplied with an alternating current,
the other of the first electrode and the second electrode is a common electrode,
an electric potential of the common electrode is set to an electric potential at an amplitude center of the alternating current which is to be applied to the pixel electrode, and
an electric potential of the third electrode is set to the electric potential at the amplitude center of the alternating current which is to be applied to the pixel electrode.

6. The liquid crystal display device according to claim 1,
wherein one of the first electrode and the second electrode is a pixel electrode which is configured to be supplied with a first alternating current,
the other of the first electrode and the second electrode is a common electrode,
an electric potential of the common electrode is set to an electric potential at an amplitude center of the first alternating current, and
the third electrode is configured to be supplied with a second alternating current which has the same phase as the first alternating current.

7. The liquid crystal display device according to claim 1,
wherein the pixel has multiple domains, and
the third electrode is disposed equally toward the multiple domains.
